(19) United States
(12) Patent Application Publication
(10) Pub. No.: US 2026/0034812 A1
(43) Pub. Date: Feb. 5, 2026

(54) PRINTING APPARATUS, CONTROL METHOD, AND STORAGE MEDIUM

(71) Applicant: CANON KABUSHIKI KAISHA, Tokyo (JP)

(72) Inventors: KEN TAKENAGA, Kanagawa (JP); MASAKAZU TSUKUDA, Kanagawa (JP); HIROTAKA ENDO, Kanagawa (JP); MASAAKI MATSUURA, Kanagawa (JP); TOMOYA HARA, Kanagawa (JP); KATSUAKI SUKEGAWA, Kanagawa (JP); TOSHIKI HAMANISHI, Kanagawa (JP)

(21) Appl. No.: 19/285,755

(22) Filed: Jul. 30, 2025

(30) Foreign Application Priority Data
Jul. 31, 2024 (JP) 2024-124742

(51) Int. Cl. B41J 13/10; B41J 3/46; B41J 11/00; B41J 13/00; B41J 29/13

(52) U.S. Cl. CPC B41J 13/106; B41J 3/46; B41J 11/006; B41J 13/0036; B41J 29/13

(57) ABSTRACT

The present disclosure aims to provide a technique for making it easy to clear a jam in a printing apparatus having a stacking unit configured to sort a printing medium in a direction orthogonal to a printing medium conveyance direction. One embodiment of the present disclosure is a printing apparatus having a casing, a conveyance unit housed in the casing and configured to convey a printing medium, and a stacking unit which is attached to the casing and on which a printing medium conveyed by the conveyance unit is be stacked. The stacking unit has a first stacking part movable in a second direction intersecting with a first direction in which a printing medium is conveyed and a second stacking part movable in the first direction relative to the first stacking part, and the stacking unit is detachable from the casing by moving in the first direction.

### BACKGROUND

### Field of the Technology

The present disclosure relates to a printing apparatus, a control method, and a storage medium.

### Description of the Related Art

A sorting technique is known to be used by a printing apparatus which discharges and stacks a printed printing medium onto a stacking unit. The technique moves the stacking unit to sort printing media into groups of a certain number of sheets. Japanese Patent Laid-Open No. 2015-160715 discloses a technique for sorting printing media, where a stacking unit is moved at an angle relative to the conveyance direction, creating a region where a bundle of printing media to be sorted does not overlap with a bundle of printing media already sorted.

However, Japanese Patent Laid-Open No. 2015-160715 does not particularly disclose a structure for removing a jammed printing medium should a paper jam occur. In the event where a paper jam occurs, a user typically needs to remove the jammed printing medium by, e.g., opening a lid on the side face and reaching into the conveyance path in the back, and this is cumbersome to the user.

Thus, the present disclosure has been made in view of the above challenge and aims to make it easy to clear a paper jam in a printing apparatus having a stacking unit configured to sort a printing medium in a direction orthogonal to a direction in which the printing medium is conveyed.

### SUMMARY

One embodiment of the present disclosure is a printing apparatus having a casing, a conveyance unit housed in the casing and configured to convey a printing medium, and a stacking unit which is attached to the casing and on which a printing medium conveyed by the conveyance unit is be stacked. The stacking unit has a first stacking part movable in a second direction intersecting with a first direction in which a printing medium is conveyed and a second stacking part movable in the first direction relative to the first stacking part, and the stacking unit is detachable from the casing by moving in the first direction.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view showing an internal configuration of a printing apparatus;

FIGS. 2A and 2B are a front view and a plan view, respectively, of a printing unit;

FIGS. 3A and 3B are diagrams illustrating a conveyance system of the printing unit;

FIG. 4 is a block configuration diagram of the printing unit, focusing on a control system for a stacking unit;

FIG. 5 is a perspective configuration view of the stacking unit;

FIGS. 6A and 6B are diagrams illustrating a range in which a second stacking part moves;

FIGS. 7A and 7B are diagrams illustrating sorting positions of the stacking unit;

FIG. 8 is a perspective configuration view of a drive transmission unit;

FIG. 9 is a perspective configuration view of a cam;

FIGS. 10A to 10C are diagrams illustrating how a reciprocating movement member is moved by the cam;

FIG. 11 is a diagram illustrating how the stacking unit is driven depending on the direction in which a drive source rotates;

FIG. 12 is a diagram showing the relationship of FIGS. 12A and 12B;

FIGS. 12A and 12B indicate a flowchart showing details of print processing;

FIGS. 13A to 13F are diagrams showing a state of the stacking unit after being driven during the print processing;

FIGS. 14A and 14B are perspective configuration views of the stacking unit;

FIGS. 15A and 15B are perspective views each showing a direction in which the stacking unit is inserted, a direction in which the stacking unit is removed, and a direction in which a printing medium is conveyed;

FIG. 16 is a perspective of a guide member;

FIGS. 17A and 17B are diagrams showing a configuration for fixating the stacking unit in position;

FIGS. 18A and 18B are diagrams showing a configuration for detecting detachment of the stacking unit from the printing apparatus and attachment of the stacking unit to the printing apparatus;

FIGS. 19A and 19B are perspective views of a configuration for determining the position of the stacking unit in an apparatus's height direction;

FIGS. 20A and 20B are sectional views of a configuration for determining the position of the stacking unit in the apparatus's height direction;

FIGS. 21A and 21B are diagrams showing the configuration of the printing apparatus in which a paper path is formed above the stacking unit;

FIGS. 22A and 22B are diagrams showing the configuration of the printing apparatus for clearing a paper jam;

FIG. 23 is a flowchart of paper jam error recovery processing; and

FIGS. 24A to 24C are diagrams each showing a user interface for jam processing.

### DESCRIPTION OF THE EMBODIMENTS

Examples of embodiments of a printing apparatus, a control method, and a program are described in detail below with reference to the drawings attached hereto. Note that the embodiments are provided below with no intention of limiting the present disclosure to them, and not all the combinations of features described in the present embodiments are necessarily essential as solutions provided by the present disclosure. Also, the positions, shapes, and the like of constituents described in the embodiments are merely exemplary, and there is no intention of limiting the scope of the present disclosure to them.

In the present embodiment, a multifunction machine is used as an example of a printing apparatus, the multifunction machine having a print function to print on a printing medium by ejecting ink (a printing material) to the printing medium using the inkjet method and a scan function to scan an original placed on a flatbed. Note that the printing method is not limited to the inkjet method, and any of various other publicly-known methods may be used, such as the electrophotographic method. A printing material that can be ejected in the printing apparatus of the present embodiment is not limited to ink, and any of various other publicly-known printing materials used for printing may be used, such as a treatment liquid used to perform a predetermined treatment on ink ejected.

Directions herein are defined as follows as seen from a position directly facing a face of the printing apparatus where a printed printing medium is discharged: an X-direction is a direction directed from the left side to the right side of the printing apparatus; a Y-direction, a direction directed from the far side (the rear side) to the near side (the front side) of the printing apparatus; and a Z-direction, a direction directed from the lower side to the upper side of the printing apparatus. In this way, the X-direction, the Y-direction, and the Z-direction are each a direction directed from the one side to the other side and are also orthogonal to one another. The directions herein are each denoted with a plus sign (+) for a direction from the one side to the other side and with a minus sign (−) for a direction from the other side to the one side.

### (Configuration of the Printing Apparatus)

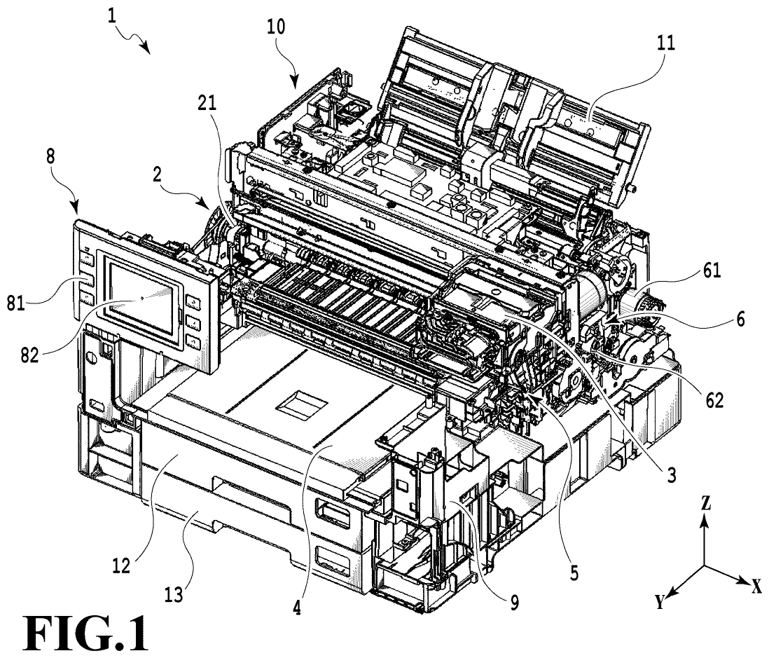

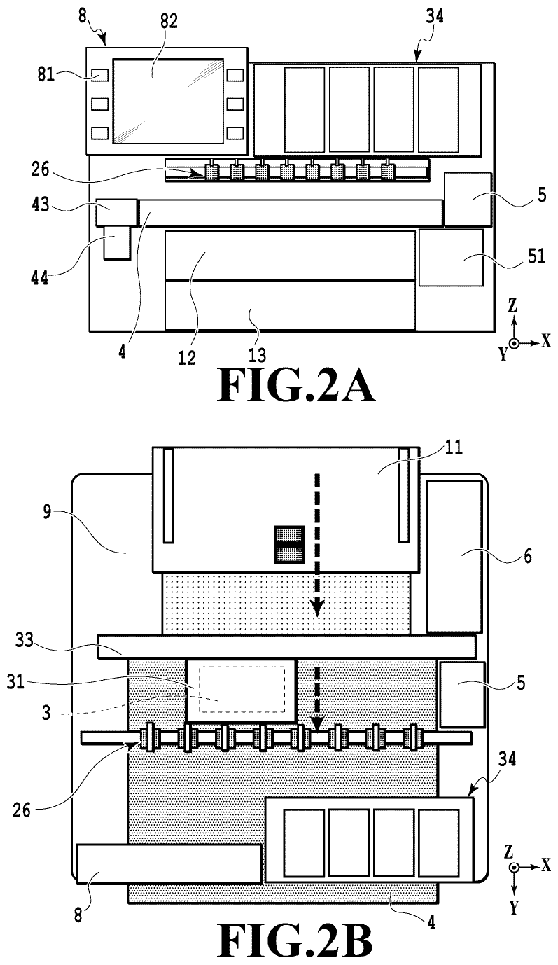

FIG. 1 is a perspective view showing an internal configuration of the printing apparatus. FIG. 2A is a front view of a printer unit, and FIG. 2B is a plan view of the printer unit. Note that FIG. 1 omits part of the configuration for ease of understanding.

A printing apparatus 1 is a multifunction machine having a printer unit 10 configured to print on a printing medium and a scanner unit (not shown) disposed above the printer unit 10 and configured to scan an original. The printing apparatus 1 executes various kinds of processing related to a printing operation and a scanning operation using the printer unit 10 and the scanner unit individually or in cooperation.

The scanner unit includes an auto document feeder (ADF) and a flatbed scanner (FBS) and is capable of scanning an original automatically fed by the ADF and scanning an original placed on the flatbed of the FBS. Note that although the printing apparatus 1 in the present embodiment is a multifunction machine having the printer unit 10 and the scanner unit, the printing apparatus 1 may be without the scanner unit.

The printer unit 10 includes a first paper feed unit 11, a second paper feed unit 12, and a third paper feed unit 13 (see FIG. 1) configured to feed a printing medium. The printer unit 10 also includes a conveyance unit 2 configured to convey a printing medium fed from one of the paper feed units, a printhead 3 configured to print on a printing medium conveyed by the conveyance unit 2 by ejecting ink thereto, and a stacking unit 4 on which to stack a printed printing medium. The printer unit 10 further includes a maintenance unit 5 configured to perform maintenance for the printhead 3 and a drive unit 6 configured to drive the first paper feed unit 11, the second paper feed unit 12, the third paper feed unit 13, and the maintenance unit 5.

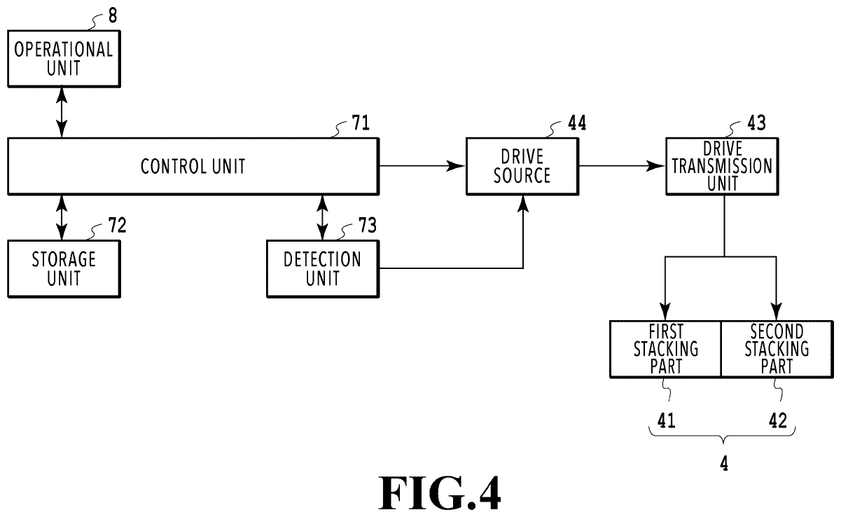

The printer unit 10 includes a liquid storage unit 34 to store ink to be supplied to the printhead 3 and an ink discharge unit 51 to store ink discharged from the maintenance unit 5 (FIGS. 2A and 2B). The printer unit 10 also includes a control unit 71 (see FIG. 4) configured to perform overall control of the operation of the printing apparatus 1, such as controlling driving of the conveyance unit 2, the printhead 3, the stacking unit 4, and the drive unit 6. The printer unit 10 further includes an operation unit 8 where a user can perform an inputting operation and where various pieces of information can be displayed. The operation unit 8 is provided with an operation button 81 used to input operational information to the printing apparatus 1 and a display panel 82 configured to display operational information. In the printing apparatus 1, the constituents described above are fastened to a casing 9, forming the printer unit 10.

In the printer unit 10, the operation unit 8 and the liquid storage unit 34 are disposed above the stacking unit 4. More specifically, the operation unit 8 and the liquid storage unit 34 are each disposed at such a position as to partially overlap with the stacking unit 4 on an XY-plane (see FIG. 2B). Note that the operation unit 8 and the liquid storage unit 34 are disposed away from the stacking unit 4 in the Z-direction (see FIG. 2A). In the present embodiment, the operation unit 8 is disposed at one side in the X-direction (the left side), and the liquid storage unit 34 is disposed at the other side in the X-direction (the right side). Note that the positions at which the operation unit 8 and the liquid storage unit 34 are disposed may be reversed in the X-direction.

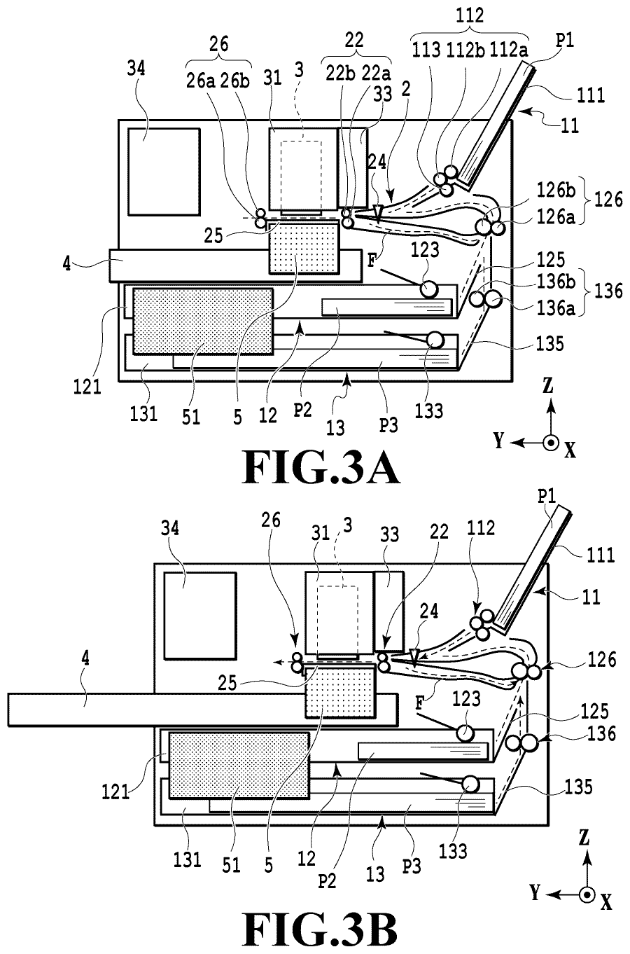

Also, in the printer unit 10, the operation unit 8 and the liquid storage unit 34 are disposed closer to the other side in the Y-direction (the front side) than a discharge roller pair 26, i.e., downstream of the discharge roller pair 26 in the direction in which a printing medium to be discharged is conveyed. Further, in the printer unit 10, the maintenance unit 5 is disposed at the other side of the stacking unit 4 in terms of the X-direction, inside the moving range of the printhead 3. More specifically, the maintenance unit 5 is disposed at such a position as to partially overlap with the stacking unit 4 on a YZ-plane (see FIG. 3A). Further, in the printer unit 10, the ink discharge unit 51 is disposed under the stacking unit 4. More specifically, the ink discharge unit 51 is disposed at such a position as to partially overlap with the stacking unit 4 on the XY-plane (see FIGS. 2A and 3A).

### (Conveyance Unit and Paper Feed Units)

Next, the configuration of a conveyance system of the printer unit 10 is described. FIGS. 3A and 3B are diagrams showing the configuration of the conveyance system of the printer unit 10, FIG. 3A showing a state before the stacking unit 4 is extended, FIG. 3B showing a state after the stacking unit 4 is extended.

### <Conveyance Unit>

The conveyance unit 2 includes a conveyance roller pair 22 configured to convey a printing medium fed from one of the paper feed units to a print position where the printhead 3 can print and the discharge roller pair 26 configured to discharge the printing medium printed by the printhead 3. The conveyance roller pair 22 includes a conveyance roller 22a driven by a conveyance motor 21 (see FIG. 1) and a pinch roller 22b which is in pressure contact with and slave-driven by the conveyance roller 22a. The conveyance roller 22a and the pinch roller 22b of the conveyance roller pair 22 nip and convey a printing medium. The discharge roller pair 26 includes a discharge roller 26a driven by the conveyance motor 21 and a spur 26b in pressure contact with the discharge roller 26a. The discharge roller 26a and the spur 26b of the discharge roller pair 26 nip and convey a printing medium.

The conveyance unit 2 also includes a first intermediate roller pair 126 configured to convey a printing medium fed from either the second paper feed unit 12 or the third paper feed unit 13 to the conveyance roller pair 22 and a second intermediate roller pair 136 configured to convey a printing medium fed from the third paper feed unit 13 to the first intermediate roller pair 126. The first intermediate roller pair 126 includes a first intermediate roller 126a driven by the drive unit 6 and a first slave roller 126b which is in pressure contact with and slave-driven by the first intermediate roller 126a. The first intermediate roller 126a and the first slave roller 126b of the first intermediate roller pair 126 nip and convey a printing medium. Also, the second intermediate roller pair 136 includes a second intermediate roller 136a driven by the drive unit 6 and a second slave roller 136b which is in pressure contact with and slave-driven by the second intermediate roller 136a. The second intermediate roller 136a and the second slave roller 136b of the second intermediate roller pair 136 nip and convey a printing medium.

Note that once a printing medium fed from one of the paper feed units passes through a detection lever 24 located upstream of the conveyance roller pair 22 in terms of the conveyance direction, the widthwise positions of the left and right leading end portions of the printing medium are aligned by the conveyance roller pair 22 relative to the conveyance direction. In other words, the conveyance roller pair 22 corrects the skew of the printing medium in the conveyance direction.

### <Paper Feed Units>

### =First Paper Feed Unit=

The first paper feed unit 11 includes a pressure plate 111 on which a printing medium is placed and a first paper feed roller unit 112 configured to feed a printing medium placed on the pressure plate 111 to the conveyance roller pair 22. The first paper feed roller unit 112 includes first paper feed rollers 112a, 112b configured to feed a printing medium to the conveyance roller pair 22. The first paper feed roller unit 112 also includes a separation roller 113 disposed at a position facing the first paper feed roller 112b and configured to give resistance to a printing medium fed by the first paper feed roller 112b. The first paper feed rollers 112a, 112b are driven by a drive force from a drive motor 61 (see FIG. 1) of the drive unit 6.

In the first paper feed unit 11, feeding of printing media P1 is started once the printing media P1 stacked on the pressure plate 111 come into contact with the first paper feed roller 112a rotating as driven by the drive motor 61. The printing media P1 fed by the first paper feed roller 112a are then fed by the first paper feed roller 112b disposed downstream of the first paper feed roller 112a in the paper feed direction. In this event, the separation roller 113 disposed at a position facing the first paper feed roller 112b feeds only the top one of the printing media P1 fed by the first paper feed roller 112b to the conveyance roller pair 22.

### =Second Paper Feed Unit=

The second paper feed unit 12 includes a cassette case 121 configured to house a printing medium, a second paper feed roller 123 configured to feed the printing medium housed in the cassette case 121, and a separator 125 configured to give resistance to the printing medium fed by the second paper feed roller 123. The second paper feed roller 123 is driven by a drive force transmitted thereto from a drive motor 62 (see FIG. 1) of the drive unit 6 through a train of gears (not shown).

In the second paper feed unit 12, feeding of A printing medium P2 housed in the cassette case 121 to the first intermediate roller pair 126 is started by the second paper feed roller 123 rotating in contact with the printing medium P2 as driven by the drive motor 62. The separator 125 gives resistance in the paper feed direction to the printing medium P2 fed by the second paper feed roller 123. As a result, even if the second paper feed roller 123 has fed a plurality of printing media P2, only the top one of the printing media P2 is fed by the separator 125 to the first intermediate roller pair 126. The printing medium P2 fed to the first intermediate roller pair 126 is conveyed to the conveyance roller pair 22 by the first intermediate roller pair 126.

### =Third Paper Feed Unit=

The third paper feed unit 13 includes a cassette case 131 configured to house a printing medium, a third paper feed roller 133 configured to feed a printing medium housed in the cassette case 131, and a separator 135 configured to give resistance to a printing medium fed by the third paper feed roller 133. The third paper feed roller 133 is driven by a drive force transmitted thereto from the drive motor 62 (see FIG. 1) of the drive unit 6 through a train of gears (not shown).

In the third paper feed unit 13, feeding of printing medium P3 housed in the cassette case 131 to the second intermediate roller pair 136 is started by the third paper feed roller 133 rotating in contact with the printing medium P3 as driven by the drive motor 62. The separator 135 gives resistance in the paper feed direction to the printing medium P3 fed by the third paper feed roller 133. As a result, even if the third paper feed roller 133 has fed a plurality of printing media P3, only the top one of the printing media P3 is fed by the separator 135 to the second intermediate roller pair 136. The printing medium P3 fed to the second intermediate roller pair 136 is conveyed to the conveyance roller pair 22 by the second intermediate roller pair 136 and the first intermediate roller pair 126.

### (Printhead)

Next, the printhead 3 is described. In the printer unit 10, the printhead 3 is mounted to a carriage 31 slidably supported by a chassis 33 extending in the X-direction and configured to be movable in a reciprocating manner in the X-direction (see FIGS. 2B and 3A). Thus, the printhead 3 is movable in a reciprocating manner in the X-direction along with the carriage 31. A printing medium conveyed by the conveyance roller pair 22 is supported by a platen 25 provided at a position facing the printhead 3. Then, the printhead 3 prints on the printing medium supported by the platen 25 by ejecting ink thereto while moving in the X-direction along with the carriage 31.

To print only on one side of the printing medium, the printed printing medium is discharged to the stacking unit 4 through the discharge roller pair 26. To print on both sides of the printing medium, with the trailing edge of the printing medium printed on one side being nipped by the discharge roller pair 26, the conveyance motor 21 is rotated reversely. As a result of this, the discharge roller pair 26 and the conveyance roller pair 22 rotate in a direction opposite to the direction in which they rotate in conveying the printing medium in the conveyance direction, conveying the printing medium whose trailing edge is nipped by the discharge roller pair 26 to a reverse conveyance path F. The trailing edge of a printing medium as referred to herein is the trailing edge of the printing medium in terms of the conveyance direction (+Y-direction), and the leading edge of a printing medium as referred to herein is the leading edge of the printing medium in terms of the conveyance direction.

Then, once the leading edge of the printing medium conveyed to the reverse conveyance path F passes through the conveyance roller pair 22, the conveyance motor 21 is switched to normal rotation. After that, once the printing medium conveyed by the first intermediate roller pair 126 passes through the detection lever 24, the skew of the printing medium is corrected by the conveyance roller pair 22 again. After this, the same operation as that for printing on one side of the printing medium is performed to print on the other side of the printing medium, and then the printing medium whose both sides have been printed is discharged to the stacking unit 4 by the discharge roller pair 26.

Note that, in the present embodiment, in printing, the stacking unit 4 where a printing medium discharged through the discharge roller pair 26 is to be stacked is automatically extended out in the +Y-direction (see FIG. 3B), as will be described in detail later. Thus, the stacking unit 4 the majority part of which is inside the casing 9 before being extended projects outside of the casing 9, creating an area where a discharged printing medium can be stably stacked.

### (Stacking Unit)

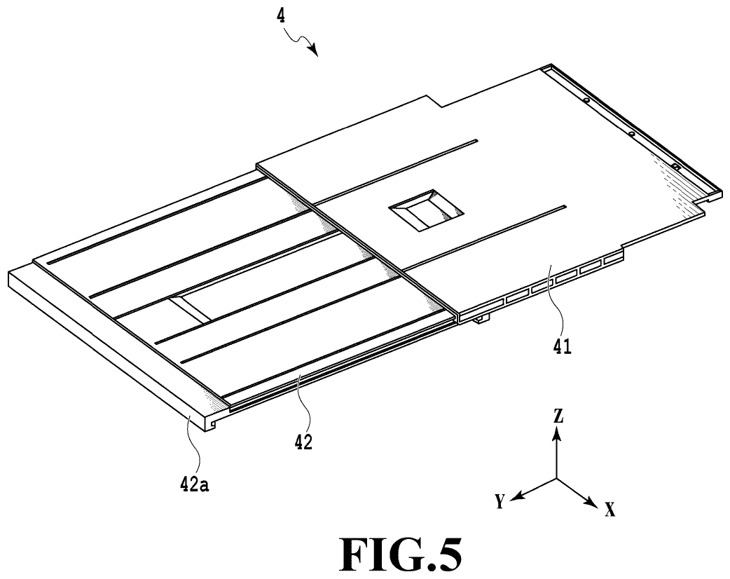

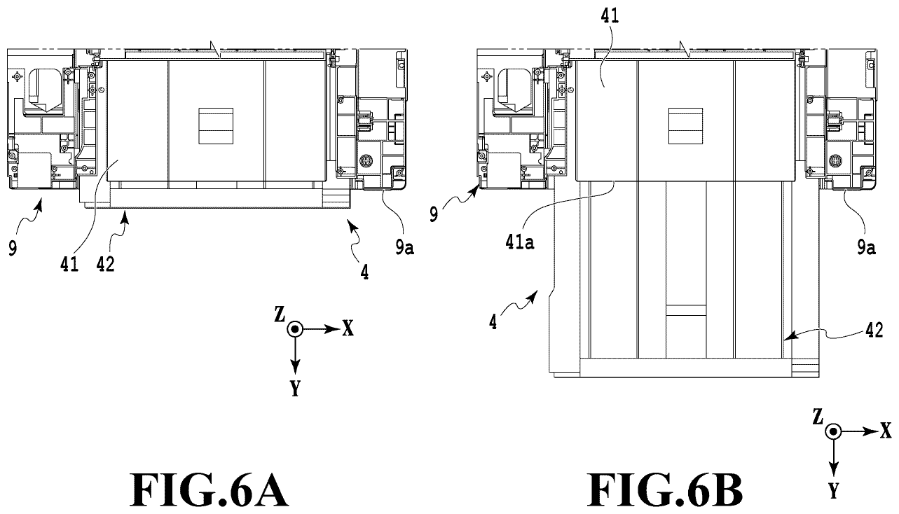

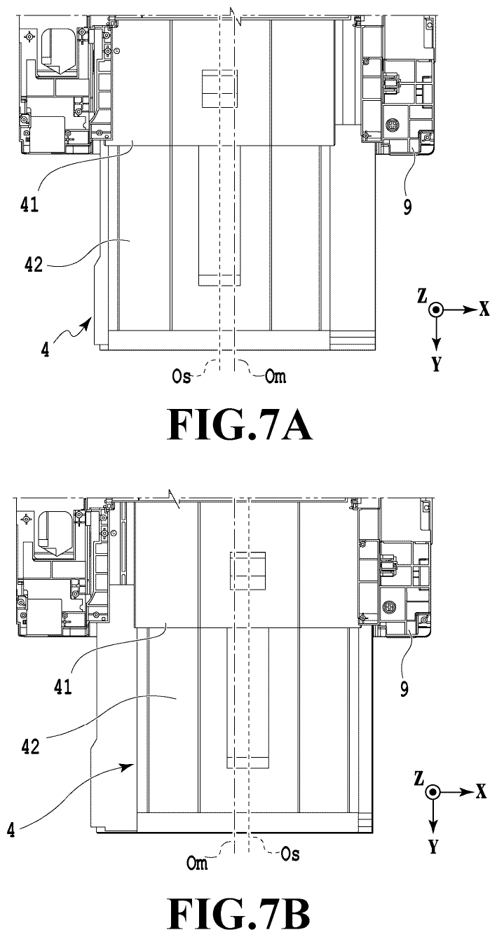

Next, the stacking unit 4 is described. FIG. 4 is a block diagram showing the configuration of a control system of the printing apparatus 1. Note that because the description below focuses on the stacking unit 4, FIG. 4 focuses on a configuration for controlling the stacking unit 4, omitting the other configurations. FIG. 5 is a perspective configuration view of the stacking unit 4. FIGS. 6A and 6B are diagrams showing the position of the stacking unit 4 after extension and the position of the stacking unit 4 after retraction, FIG. 6A showing a second stacking part 42 at a housed position with the stacking unit 4 being retracted, FIG. 6B showing the second stacking part 42 at a stack position with the stacking unit 4 being extended. FIGS. 7A and 7B are diagrams showing two sorting positions of the stacking unit 4, FIG. 7A showing a first sorting position, FIG. 7B showing a second sorting position.

The stacking unit 4 on which to stack a printing medium discharged by the discharge roller pair 26 is automatically extended once printing starts, expanding the area to support the printing medium discharged. Also, the stacking unit 4 automatically retracts once the printing medium is removed from the stacking unit 4, reducing the aforementioned area. Further, the stacking unit 4 has a function to move in a direction (the X-direction) intersecting with (in the present embodiments, orthogonal to) the direction in which the stacking unit 4 extends and retracts (the Y-direction) and sort a printing medium discharged. Note that the automatic retraction of the stacking unit 4 in the printer unit 10 is executed not only upon removal of a printing medium from the stacking unit 4, but also in the following cases: an instruction from a user is received through the operation unit 8, a printing operation is not performed for a predetermined period of time, mode is switched to power-saving mode, or the like.

The printer unit 10 includes the control unit 71, a storage unit 72, a detection unit 73, the operation unit 8, the stacking unit 4, a drive transmission unit 43, and a drive source 44 (see FIG. 4).

After receiving a print instruction, the control unit 71 completes movement of the stacking unit 4 in the X-direction and extension of the stacking unit 4 in the Y-direction before a printing medium is conveyed and discharged to the stacking unit 4. Also, once a printing medium is removed from the stacking unit 4, the control unit 71 starts moving the stacking unit 4 in the X-direction and retracting the stacking unit 4 in the Y-direction. As will be described in detail later, the stacking unit 4 is extended after moving in the X-direction to the first sorting position (to be described later). As a result of the extension of the stacking unit 4, the second stacking part 42 constituting the stacking unit 4 moves from the housed position (to be described later) to the stack position (to be described later). Also, the stacking unit 4 is retracted after moving in the X-direction to the second sorting position (to be described later) different from the first sorting position. As a result of the retraction of the stacking unit 4, the second stacking part 42 constituting the stacking unit 4 moves from the stack position to the housed position. This control enables a printing medium to be less affected by an external force resulting from the stacking unit 4 moving during discharge of the printing medium. This means neat alignment of print media discharged and stacked, offering good visibility between sorted sets of printing media. Also, because the stacking unit 4 automatically extends, there is no burden on the user, improving usability. Note that drive control performed by the control unit 71 for, e.g., movement and extension of the stacking unit 4, will be described in detail later.

The operation unit 8 includes the operation button 81 and the display panel 82 (see FIG. 1). By operating the operation unit 8, the user can select whether to sort printing media or can instruct to move the stacking unit 4. Note that in the printer unit 10, sorting of printing media and moving of the stacking unit 4 can also be executed based on, for example, information set in a job. Various programs used in operating the stacking unit 4 are stored in the storage unit 72. Based on a user input entered through the operation unit 8, the control unit 71 reads a program suitable for the user input and controls driving of the stacking unit 4. The storage unit 72 also holds a result of detection by the detection unit 73.

The detection unit 73 includes a plurality of sensors. Specifically, the detection unit 73 includes a sensor configured to detect rotation of the drive source 44 (see FIG. 2A) for driving the stacking unit 4. This sensor is configured of a rotary encoder and installed on the rotary shaft of the drive source 44 which generates a rotary drive force. This sensor converts the angle of rotation of the drive source 44 into a step count and transmits the step count to the control unit 71. The control unit 71 reads a step count necessary for the stacking unit 4 to perform a predetermined operation from the storage unit 72, and once a step count transmitted from the sensor reaches the prescribed step count, the control unit 71 determines that the predetermined operation by the stacking unit 4 is complete and stops the drive source 44. Although this sensor is configured by an encoder provided on the rotary shaft of the drive source 44 in the present embodiments, the present disclosure is not limited to this. For example, the sensor may be provided on the rotary shaft of a predetermined transmission member constituting the drive transmission unit 43 (see FIG. 2A) configured to transmit a drive force from the drive source 44 to the stacking unit 4.

The detection unit 73 also includes a sensor configured to detect the position of the stacking unit 4 after a predetermined operation. For example, a mechanical switch, a photosensor, a rotary encoder of the drive source 44, or the like can be used as this sensor. The detection unit 73 further includes a sensor configured to detect whether a printing medium is stacked on the stacking unit 4. This sensor can detect the timing to retract the stacking unit 4.

The stacking unit 4 includes a first stacking part 41 and the second stacking part 42 (see FIG. 5). The first stacking part 41 is configured to be movable in a reciprocating manner in the X-direction intersecting with the direction in which a printing medium is discharged (the Y-direction). The first stacking part 41 is disposed inside the casing 9, with its end portion 41a on the other side in the Y-direction being located rearward of a front face 9a of the casing 9 in the Y-direction (see FIG. 6A and FIG. 6B).

The second stacking part 42 is supported by the first stacking part 41 and configured to be movable in the first stacking part 41 in a reciprocating manner in the Y-direction. Thus, the second stacking part 42 is configured to be movable in a reciprocating manner in the X-direction along with the first stacking part 41.

The second stacking part 42 is configured to be movable between the housed position and the stack position (see FIGS. 6A and 6B). The housed position is a position where the second stacking part 42 is housed under the first stacking part 41 with a majority part thereof overlapping with the first stacking part 41 on the XY-plane (see FIG. 6A). The stack position is a position where the second stacking part 42 has been drawn out from the housed position and allows a printing medium to be stacked thereon in cooperation with the second stacking part 42 (see FIG. 6B). In other words, in extension of the stacking unit 4, the second stacking part 42 moves in the +Y-direction from the housed position to the stacked position. Also, in retraction of the stacking unit 4, the second stacking part 42 moves in the −Y-direction from the stack position to the housed position. Note that in the present embodiment, at the housed position, a part of the second stacking part 42 on an end portion 42a side protrudes more in the Y-direction than the front face 9a of the casing 9. With such a configuration, with the second stacking part 42 at the housed position, a majority part of the stacking unit 4 is located inside the casing 9, which makes it possible to reduce the space for installing the printing apparatus 1.

Regarding the stack position, the second stacking part 42 can take a plurality of positions in the Y-direction depending on the size of a printing medium. In the present embodiment, the second stacking part 42 can take four stack positions corresponding to A4, A5, B5, and letter sizes. Note that the stack positions that may be taken are not limited to the above.

Also, the stacking unit 4 is configured to be movable between the two sorting positions for sorting discharged printing media by having the first stacking part 41 move in the X-direction. Specifically, the stacking unit 4 is movable in the X-direction between the first sorting position (see FIG. 7A) where a center position Os of the stacking unit 4 is located more toward one side than a center position Om of a discharged printing medium and the second sorting position (see FIG. 7B) where the center position Os is located more toward the other side than the center position Om. The stacking unit 4 is configured to be capable of sorting discharged printing media at positions offset from each other in the X-direction by allowing a printing medium to be stacked thereon at the first sorting position and allowing a printing medium to be stacked thereon at the second sorting position. In other words, the first sorting position and the second sorting position are located apart in the X-direction by a predetermined distance.

In the present embodiment, the distance from the center position Os to the center position Om at the first sorting position may be the same as the distance from the center position Os to the center position Om at the second sorting position. Alternatively, the distance from the center position Os to the center position Om at the first sorting position may be different from the distance from the center position Os to the center position Om at the second sorting position. The distance necessary for sorting, i.e., the distance between the first sorting position and the second sorting position is, for example, 30 mm or longer and 50 mm or shorter. The positions where the stacking unit 4 can stay are not limited to the first sorting position and the second sorting position. For example, the stacking unit 4 may be configured to be located at the center position Om while, for example, no sorting of printing media is performed even though print processing is being performed or while no printing is performed.

### (Drive Transmission Unit)

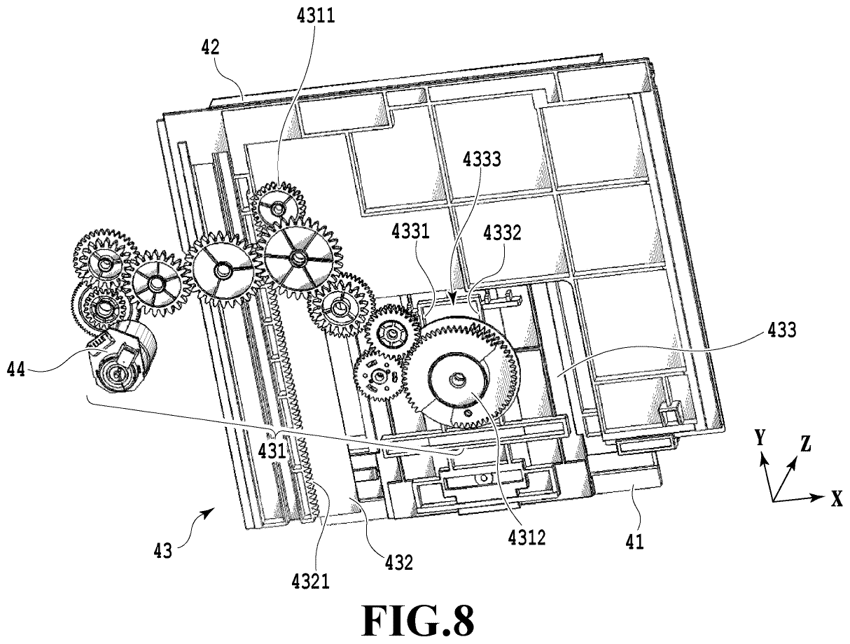

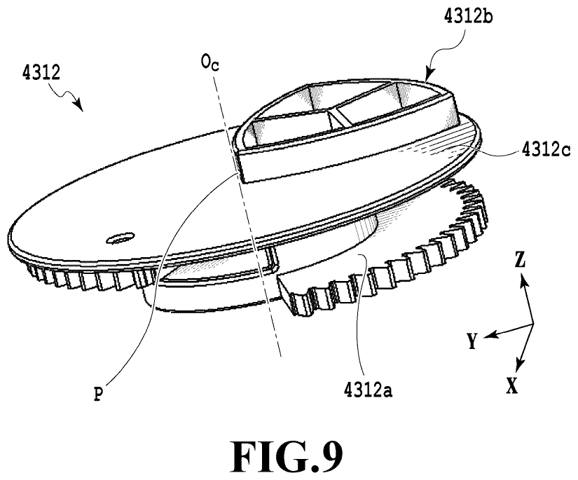

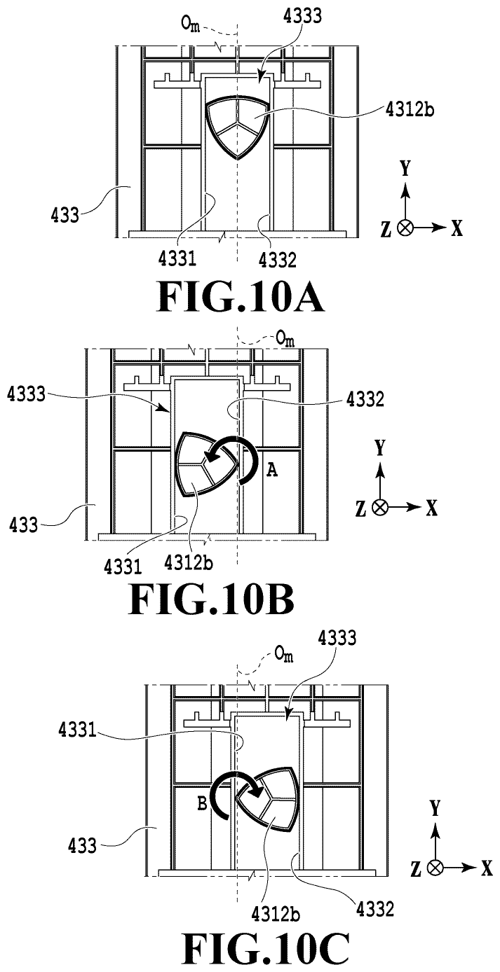

Next, the drive transmission unit 43 is described. FIG. 8 is a perspective view of the drive transmission unit 43. FIG. 9 is a perspective view of a cam 4312, which is a constituent of the drive transmission unit 43. FIGS. 10A to 10C are diagrams illustrating how the stacking unit 4 is moved in the X-direction by the cam 4312.

The drive transmission unit 43 includes: a drive train 431 formed by a plurality of drive transmission members configured to transmit a rotational drive force from the drive source 44; and a support member 432 which can be moved in the Y-direction by the drive force transmitted through the drive train 431 (see FIG. 8). The drive transmission unit 43 also includes a reciprocating movement member 433 which can be moved in the X-direction by the drive force transmitted through the drive train 431 and a case (not shown) holding the drive source 44 and the drive train 431.

The support member 432 includes a rack portion 4321 extending in the Y-direction. This rack portion 4321 meshes with a pinion 4311, which is one of the drive transmission members forming the drive train 431, and this enables the support member 432 to move in the Y-direction as driven by the drive force transmitted from the drive train 431. Specifically, the drive train 431 is formed by a plurality of gears including the pinion 4311. The drive force transmitted from the drive source 44 is transmitted to the pinion 4311 through predetermined gears in the drive train 431, and the drive force transmitted to the pinion 4311 causes the support member 432 to move in the Y-direction.

One end of the drive train 431 is connected to the drive source 44, and the other end of the drive train 431 is where the cam 4312 to engage with the reciprocating movement member 433 is located. The cam 4312 includes a circular plate portion 4312c, a gear portion 4312a formed at one surface of the plate portion 4312c, and a cam portion 4312b formed at the other surface of the plate portion 4312c (see FIG. 9). As driven by the drive force transmitted from the drive source 44 to the gear portion 4312a, the cam 4312 rotates about an axis Oc passing through the center of the plate portion 4312c and parallel to the Z-direction. In the present embodiment, the cam portion 4312b has a substantially triangular, tubular shape whose sides that connect adjacent ones of the vertices of the triangle curve gently, protruding outward (see FIG. 10A). Meanwhile, the cam portion 4312b is formed at the other surface of the plate portion 4312c with its center offset from the rotation center, so that a predetermined vertex P of the cam portion 4312b may be located on the axis Oc.

The reciprocating movement member 433 has an engagement portion 4333 to engage with the cam portion 4312b. The engagement portion 4333 has a first sliding surface 4331 and a second sliding surface 4332 against which the cam portion 4312b in engagement is slidable, with the first sliding surface 4331 and the second sliding surface 4332 facing with a predetermined gap interposed therebetween in the X-direction. Note that the predetermined gap corresponds to the length of the cam portion 4312b in the X-direction. Also, the first sliding surface 4331 and the second sliding surface 4332 are formed in parallel with the Y-direction. As described earlier, the cam portion 4312b has its center offset from the rotation center of the cam 4312. For this reason, as the cam 4312 rotates, the cam portion 4312b slides against the first sliding surface 4331 or the second sliding surface 4332 and moves the reciprocating movement member 433 in the +X-direction or the −X-direction (see FIGS. 10A to 10C).

As an example, a case is considered here where as a result of the cam 4312 rotating, the cam portion 4312b rotates from a predetermined position (the position shown in FIG. 10A) in the direction indicated by arrow A (see FIG. 10B). In this case, the cam portion 4312b slides against the first sliding surface 4331, moving the reciprocating movement member 433 from the other side to one side in the X-direction (the −X-direction) (see FIG. 10B). Also, a case is considered here where as a result of the cam 4312 rotating, the cam portion 4312b rotates from the predetermined position in the direction indicated by arrow B (see FIG. 10C). In this case, the cam portion 4312b slides against the second sliding surface 4332, moving the reciprocating movement member 433 from the one side to the other side in the X-direction (the +X-direction) (see FIG. 10C).

The support member 432 is connected to the second stacking part 42. Thus, the second stacking part 42 moves in the Y-direction in conjunction with movement of the support member 432 in the Y-direction. Meanwhile, the reciprocating movement member 433 is connected to the first stacking part 41. Thus, in conjunction with movement of the reciprocating movement member 433 in the X-direction, the first stacking part 41 moves in the X-direction, and the second stacking part 42 moves in the X-direction along with the first stacking part 41. Although the support member 432 is connected to the second stacking part 42 and the reciprocating movement member 433 is connected to the first stacking part 41 in the present embodiment, the present disclosure is not limited to this. For example, the second stacking part 42 may have the function of the support member 432 by having the rack portion 4321 formed at the second stacking part 42, or the first stacking part 41 may have the function of the engagement portion 4333 by having the engagement portion 4333 formed at the first stacking part 41.

### (Overview of How the First Stacking Part and the Second Stacking Part Move)

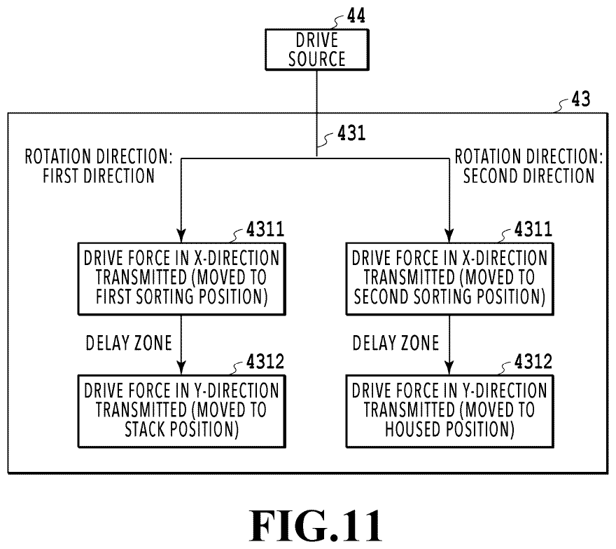

Next, an overview of how the first stacking part 41 and the second stacking part 42 move is described. FIG. 11 is a diagram showing an overview of how the first stacking part 41 and the second stacking part 42 move.

In the drive train 431, a delay zone is provided in a drive transmission path in the Y-direction. Specifically, the drive train 431 is configured so that the second stacking part 42 starts moving in the Y-direction after the first stacking part 41 completes its movement in the X-direction. More specifically, in the event where the drive source 44 rotates in a first direction, the first stacking part 41 moves to the first sorting position, and the second stacking part 42 too moves to the first sorting position along with the first stacking part 41. After that, as the drive source 44 rotates further in the first direction, the second stacking part 42 is extended relative to the first stacking part 41, i.e., the second stacking part 42 at the housed position is moved in the +Y-direction to the stack position. In the event where the drive source 44 rotates in a second direction which is opposite from the first direction, the first stacking part 41 is moved to the second sorting position, and the second stacking part 42 is also moved to the second sorting position along with the first stacking part 41. After that, as the drive source 44 rotates further in the second direction, the second stacking part 42 is retracted relative to the first stacking part 41, i.e., the second stacking part 42 at the stack position moves in the −Y-direction to the housed position.

Although the drive transmission unit 43 in the present embodiment moves the first stacking part 41 in the X-direction and then moves the second stacking part 42 in the Y-direction, the present disclosure is not limited to this. For example, the drive transmission unit 43 may move the second stacking part 42 in the Y-direction and then move the first stacking part 41 in the X-direction. Also, any of various publicly-known transmission mechanisms, such as a link mechanism, may be used as a configuration for transmitting a drive force from the drive source 44. Further, the printer unit 10 may have a plurality of drive sources so that movement of the first stacking part 41 in the X-direction and movement of the second stacking part 42 in the Y-direction may be executed by drive forces from different drive sources. Note that movement of the first stacking part 41 in the X-direction and movement of the second stacking part 42 in the Y-direction may be executable not only by the drive source 44, but also by a user manually.

### (Print Processing)

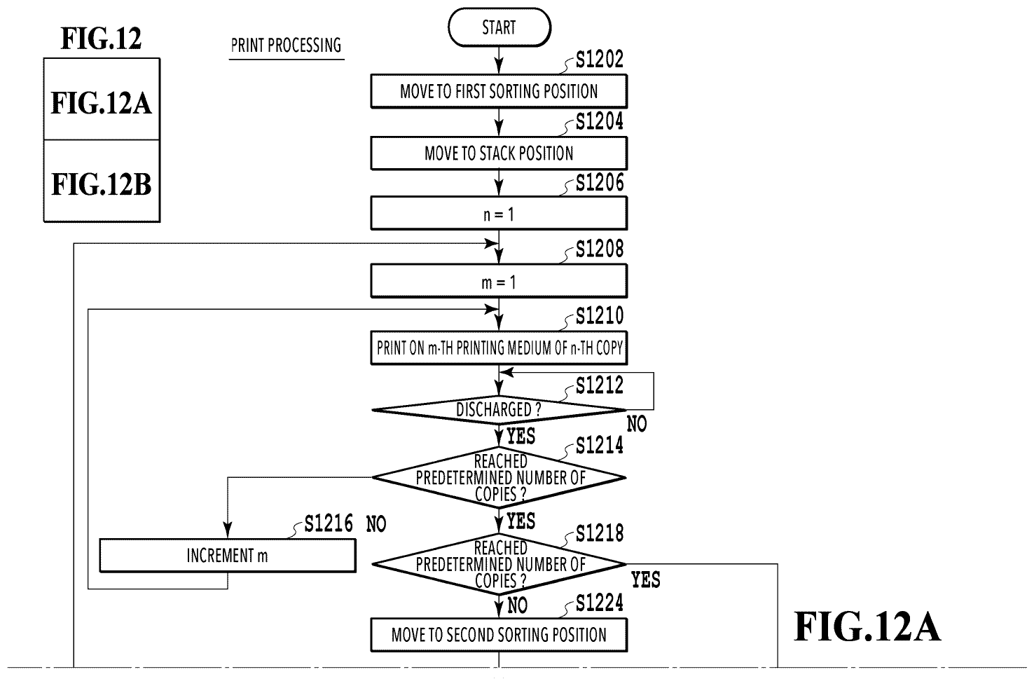

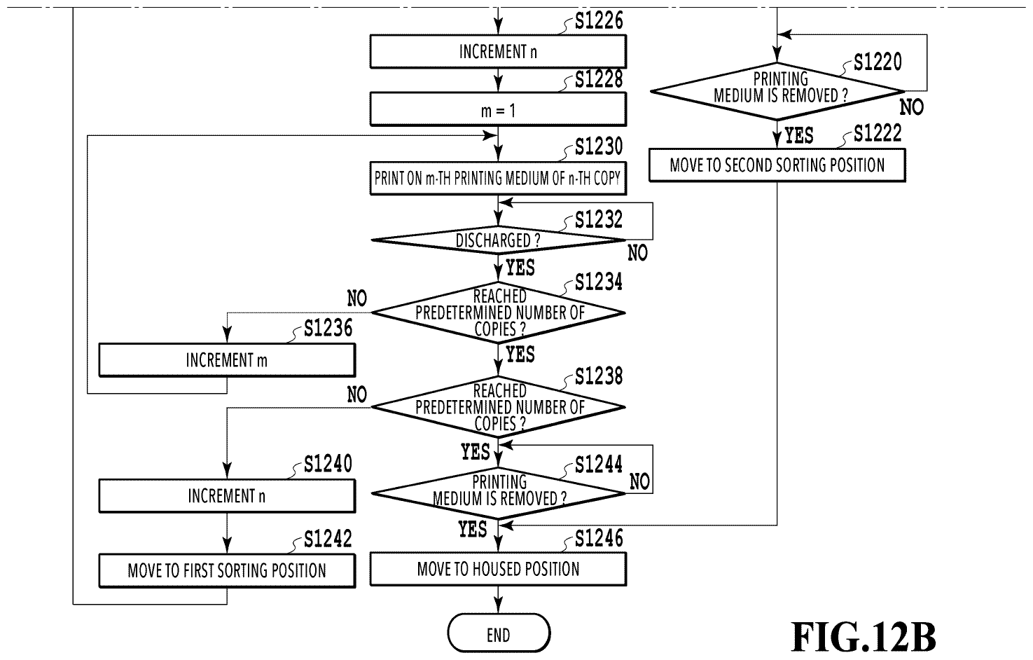

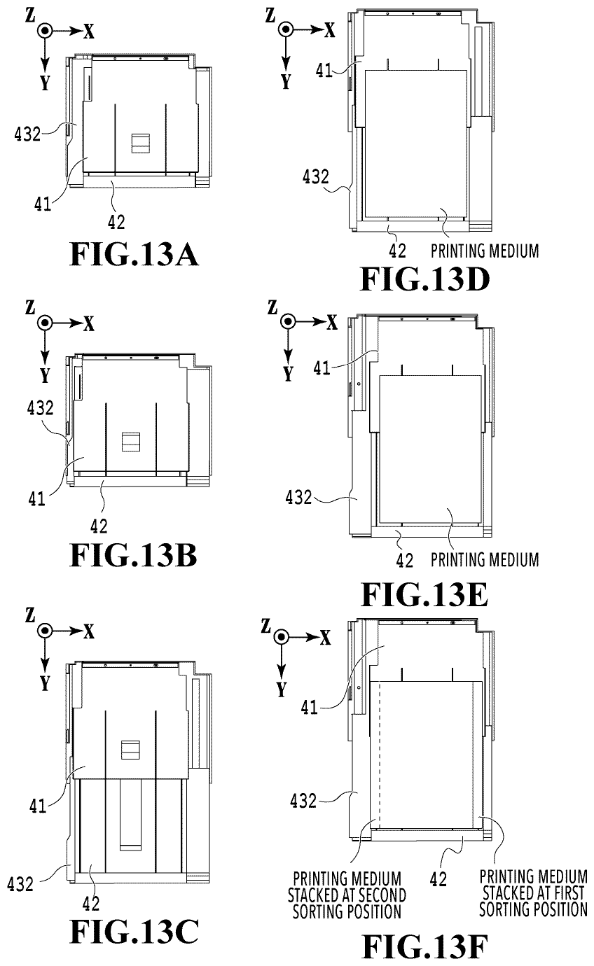

Next, print processing is described, where a printing medium is printed and is sorted by the stacking unit 4 after being printed. FIGS. 12A and 12B indicate a flowchart showing details of the print processing where a printing medium is printed and is sorted by the stacking unit 4 after being printed. FIGS. 13A to 13F are diagrams showing a state after the stacking unit 4 is moved. The series of processing steps shown in the flowchart in FIGS. 12A and 12B is performed by the control unit 71 by loading program code stored in program memory (not shown) of the storage unit 72 into data memory (not shown) of the storage unit 72 and executing the program code. Alternatively, some or all of the functions of the steps in FIGS. 12A and 12B may be executed by hardware such as an application-specific integrated circuit (ASIC) or an electric circuit. The letter “S” used herein in the description of each process in the flowchart means that it is a step in the flowchart. Note that the following describes, using FIGS. 12A and 12B, a case where the printing apparatus 1 executes print processing based on a job instructing to print and generate N copies of M sheets of printing media, with one copy being a bundle of M printing media.

Once print processing starts, first in S1202, the control unit 71 moves the first stacking part 41 and the second stacking part 42 to the first sorting position. In S1202, the drive source 44 is rotated in the first direction to move the first stacking part 41 and the second stacking part 42 located at the initial position (see FIG. 13A) in the −X-direction to the first sorting position (see FIG. 13B). Next, in S1204, the control unit 71 moves the second stacking part 42 from the housed position to the stack position. In S1204, with the first stacking part 41 and the second stacking part 42 located at the first sorting position, the drive source 44 is rotated further in the first direction to move the second stacking part 42 in the +Y-direction from the housed position to the stack position (see FIG. 13C). In the present embodiment, the stack position varies depending on the size of the printing medium. More specifically, in the present embodiment, how much the stacking unit 4 is extended differs depending on the size of the printing medium. Thus, in S1204, the stack position is determined based on a result of detection by a sensor included in the detection unit 73 and configured to detect the position of the stacking unit 4 after a predetermined operation. Specifically, for example, based on a result of detection by the rotary encoder on the drive source 44, the second stacking part 42 is moved to the stack position suitable for the size of the printing medium. In an alternative configuration, based on a result of detection by a mechanical switch, a photosensor, or the like, the second stacking part 42 may be moved to the stack position suitable for the size of the printing medium.

The drive transmission unit 43 is formed so that, with the first stacking part 41 located at the first sorting position, the cam 4312 will not rotate further even in the event where the drive source 44 rotates in the first direction and transmits a drive force thereto. For this reason, in S1204, even in the event where the drive source 44 rotates in the first direction with the first stacking part 41 and the second stacking part 42 located at the first sorting position, the first stacking part 41 and the second stacking part 42 do not move in the −X-direction from the first sorting position.

Next, in S1206, the control unit 71 sets a variable n to “1,” the variable n indicating the number of the copy which is a bundle of printing media to be sorted now. Also, in S1208, the control unit 71 sets a variable m to “1,” the variable m indicating the number of a printing medium to be printed now. After that, in S1210, the control unit 71 performs printing on the m-th printing medium of the n-th copy. The printer unit 10 performs a printing operation by ejecting ink to a predetermined region, which is supported by the platen 25, on the printing medium conveyed by the conveyance unit 2, while moving the printhead 3 in the X-direction. Next, after the conveyance unit 2 performs a conveyance operation of conveying the printing medium by a predetermined amount corresponding to the Y-direction length of the predetermined region, a printing operation is executed again. In this way, the printer unit 10 prints on the printing medium by repeating the printing operation and the conveyance operation alternately. Thus, the printing medium being printed is conveyed more and more in the +Y-direction as it is printed, and then once the printing is finished, is discharged and stacked on the stacking unit 4 which is extended and located at the first sorting position.

Then, in S1212, the control unit 71 determines whether the printing medium has been discharged. In S1212, for example, the control unit 71 makes the determination based on a result of detection by a sensor included in the detection unit 73 and configured to detect discharge of a printing medium, and the control unit 71 also counts the number of printing media discharged. The printing medium discharged is stacked on the stacking unit 4 located at the first sorting position (see FIG. 13D).

In the present embodiment, printing on the first printing medium of the first copy is started after moving the first stacking part 41 and the second stacking part 42 to the first sorting position and moving the second stacking part 42 to the stack position. However, the present disclosure is not limited to this. The aforementioned movement of the first stacking part 41 and the second stacking part 42 only needs to be completed at least before the first printing medium of the first copy is discharged, and this movement and the printing on the first printing medium of the first copy may be executed in parallel. Note that what is meant by “before the first printing medium of the first copy is discharged to the stacking unit 4” is, for example, “before the first printing medium of the first copy is discharged and placed on the stacking unit 4.”

After that, in S1214, the control unit 71 determines whether the number of printing media discharged has reached a predetermined number of sheets. In S1214, the control unit 71 determines whether the count of the printing media discharged has reached the predetermined number of sheets set in advance. Alternatively, in S1214, the control unit 71 determines whether the sheet number m has reached the predetermined number of sheets. In this case, in S1212, the control unit 71 does not count the number of printing media discharged. The predetermined number of sheets is set based on, for example, information set in the job. In other words, in the present embodiment, the predetermined number of sheets is “M,” and it is determined in S1214 whether m=M.

If it is determined in S1214 that the number of printing media discharged has not reached the predetermined number of sheets yet, the control unit 71 proceeds to S1216 to increment m and proceeds back to S1210. If it is determined in S1214 that the number of printing media discharged has reached the predetermined number of sheets, the control unit 71 proceeds to S1218 to determine whether the copy number n has reached a predetermined number of copies. The predetermined number of copies is set based on, for example, information set in the job. Thus, in the present embodiment, the predetermined number of copies is “N,” and it is determined in S1208 whether n=N.

If it is determined in S1218 that the copy number n has reached the predetermined number of copies, the control unit 71 proceeds to S1220 and determines whether the printing media have been removed from the stacking unit 4. In S1220, the control unit 71 makes the determination based on a result of detection by a sensor included in the detection unit 73 and configured to detect whether there is any printing medium stacked on the stacking unit 4. If it is determined in S1220 that the printing media have not been removed from the stacking unit 4, the processing in S1220 is performed again. In this event, through the display panel 82 of the operation unit 8, the user may be notified and prompted to remove the printing media from the stacking unit 4. If it is determined in S1220 that the printing media have been removed from the stacking unit 4, the control unit 71 proceeds to S1222 and moves the first stacking part 41 and the second stacking part 42 to the second sorting position. In S1222, the drive source 44 is rotated in the second direction to move the first stacking part 41 and the second stacking part 42 located at the first sorting position in the +X-direction to the second sorting position, and the processing proceeds to S1246 to be described later.

If it is determined in S1218 that the copy number n has not reached the predetermined number of copies yet, the control unit 71 proceeds to S1224 and moves the first stacking part 41 and the second stacking part 42 to the second sorting position (see FIG. 13E). Details of the processing in S1224 are the same as S1222 described above and are therefore not described here. Next, in S1226, the control unit 71 increments the variable n. Also, in S1228, the control unit 71 sets the variable m to “1.” After that, in S1230, the control unit 71 performs printing on the m-th printing medium of the n-th copy. The printing medium being printed is conveyed more and more in the +Y-direction as it is printed, and once the printing is finished, is discharged and stacked on the stacking unit 4 which is extended and located at the second sorting position. Then, in S1232, the control unit 71 determines whether the printing medium has been discharged. The printing medium discharged here is stacked on the printing medium stacked on the stacking unit 4 at the first sorting position, so that the printing medium discharged here is stacked on the printing medium stacked at the first sorting position, at a position offset in the X-direction (see FIG. 13F).

In the present embodiment, the first printing medium of the n-th copy is printed after the first stacking part 41 and the second stacking part 42 are moved to the second sorting position. However, the present disclosure is not limited to this. The movement of the first stacking part 41 and the second stacking part 42 to the second sorting position only needs to be completed at least before the first printing medium of the n-th copy is discharged to the stacking unit 4, and this movement and the printing on the first printing medium of the n-th copy may be executed in parallel. Note that what is meant by “before the first printing medium of the first copy is discharged to the stacking unit 4” is, for example, “before the first printing medium of the n-th copy is discharged and placed on the printing medium stacked on the stacking unit 4.”

After that, in S1234, the control unit 71 determines whether the number of printing media discharged has reached the predetermined number of sheets. If it is determined in S1234 that the number of printing media discharged has not reached the predetermined number of sheets yet, the control unit 71 proceeds to S1236 to increment m and proceeds back to S1230. If it is determined in S1234 that the number of printing media discharged has reached the predetermined number of sheets, the control unit 71 proceeds to S1238 to determine whether the copy number n has reached the predetermined number of copies. Note that details of the processing from S1232 to S1238 described above are the same as S1212 to S1218 described earlier and are therefore not described here.

If it is determined in S1238 that the copy number n has not reached the predetermined number of copies, the control unit 71 proceeds to S1240 and increments n. Then in S1242, the control unit 71 moves the first stacking part 41 and the second stacking part 42 to the first sorting position and proceeds back to S1208. In S1242, the drive source 44 rotates in the first rotation to move the first stacking part 41 and the second stacking part 42 located at the second sorting position in the −X-direction to the first sorting position.

In the present embodiment, after the first stacking part 41 and the second stacking part 42 are moved to the first sorting position in S1242, the processing proceeds back to S1208 to print the first printing medium of the n-th copy. However, the present disclosure is not limited to this. The movement of the first stacking part 41 and the second stacking part 42 to the first sorting position in S1242 only needs to be completed at least before the first printing medium of the n-th copy is discharged to the stacking unit 4, and this movement and the printing on the first printing medium of the n-th copy may be executed in parallel.

If it is determined in S1238 that the copy number n has reached the predetermined number of copies, the control unit 71 proceeds to S1244 and determines whether the printing media have been removed from the stacking unit 4. Details of the processing in S1244 are the same as S1220 described above and are therefore not described here. If it is determined in S1244 that the printing media have not been removed from the stacking unit 4, the processing in S1244 is performed again. In this event, through the display panel 82 of the operation unit 8, the user may be notified and prompted to remove the printing media from the stacking unit 4. If it is determined in S1244 that the printing media have been removed from the stacking unit 4, the control unit 71 proceeds to S1246 to move the second stacking part 42 from the stack position to the housed position and ends this print processing. Note that, in ending the print processing, for example, the first stacking part and the second stacking part 42 which is located at the housed position are moved to the initial position (see FIG. 13A).

In S1246, the drive source 44 is rotated further in the second direction with the first stacking part 41 and the second stacking part 42 located at the second sorting position, thereby moving the second stacking part 42 in the −Y-direction from the stack position to the housed position. The drive transmission unit 43 is formed so that, with the first stacking part 41 located at the second sorting position, the cam 4312 will not rotate further even in the event where the drive source 44 rotates in the second direction and transmits a drive force thereto. For this reason, in S1246, even in the event where the drive source 44 is rotated in the second direction with the first stacking part 41 and the second stacking part 42 located at the second sorting position, the first stacking part 41 and the second stacking part 42 do not move in the +X-direction from the second sorting position.

In this way, in the present embodiment, the control unit 71, the drive source 44, and the drive transmission unit 43 function as a control unit configured to control the movement of the stacking unit 4 including the first stacking part 41 and the second stacking part 42.

### Advantageous Effects

As thus described, the printing apparatus 1 sorts a printed printing medium by moving the stacking unit 4, which is configured to allow a printing medium to be stacked thereon, in the X-direction orthogonal to the Y-direction (the direction in which the printing medium is conveyed) before the first printing medium of the n-th copy is discharged. Also, before the first printing medium printed by the print processing (i.e., the first sheet of the first copy) is discharged to the stacking unit 4, the second stacking part 42 of the stacking unit 4 is moved from the housed position to a stack position suitable for the size of the printing medium, creating a stacking area enough for the size of the printing medium. Further, once printing media are removed from the stacking unit 4, the second stacking part 42 of the stacking unit 4 is moved from the stack position to the housed position overlapping with the first stacking part 41 on the XY-plane and is housed inside the casing 9.

Thus, before discharge of a printing medium printed, the printing apparatus 1 can automatically extend the stacking unit 4 from the housed position where it is housed inside the casing 9 to the stack position suitable for the size of the printing medium and can also automatically move the stacking unit 4 to the sorting position. Also, after removal of the printing media from the stacking unit 4, the printing apparatus 1 can automatically retract the stacking unit 4 from the stack position suitable for the size of the printing medium to the housed position where it is housed inside the casing 9. Thus, the printing apparatus 1 does not require user intervention to move the stacking unit 4, and the stacking unit 4 can be housed inside the casing 9 while not in use, which contributes to size reduction of the apparatus without compromising useability.

### First Embodiment

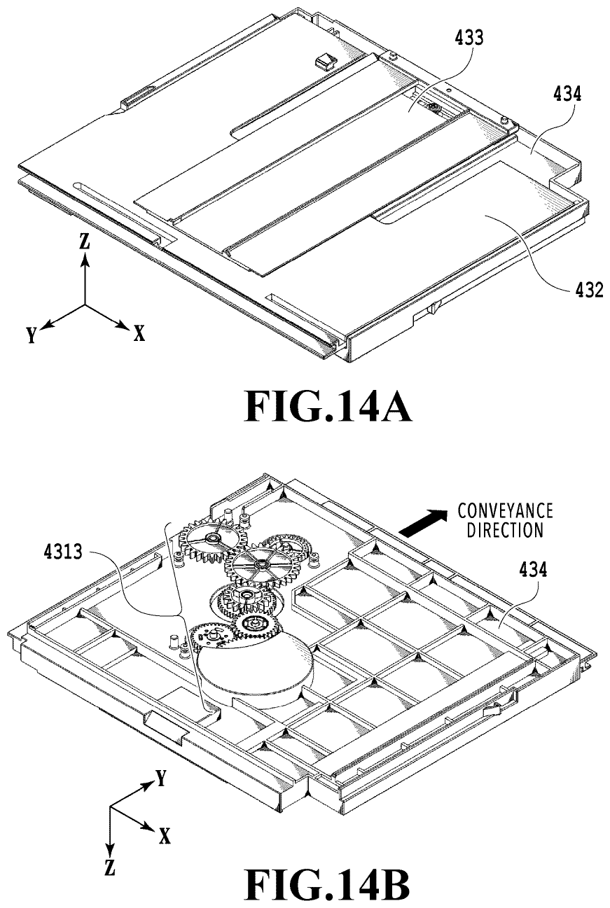

FIGS. 14A and 14B are perspective configuration diagrams of the stacking unit 4 of the present embodiment. As shown in FIG. 14A, the stacking unit 4 is formed by a second support member 432 configured to move in the conveyance direction, the reciprocating movement member 433 configured to move in the width direction, and a first support member 434 having a slidable fitting shape (not shown) to allow the second support member 432 and the reciprocating movement member 433 to move.

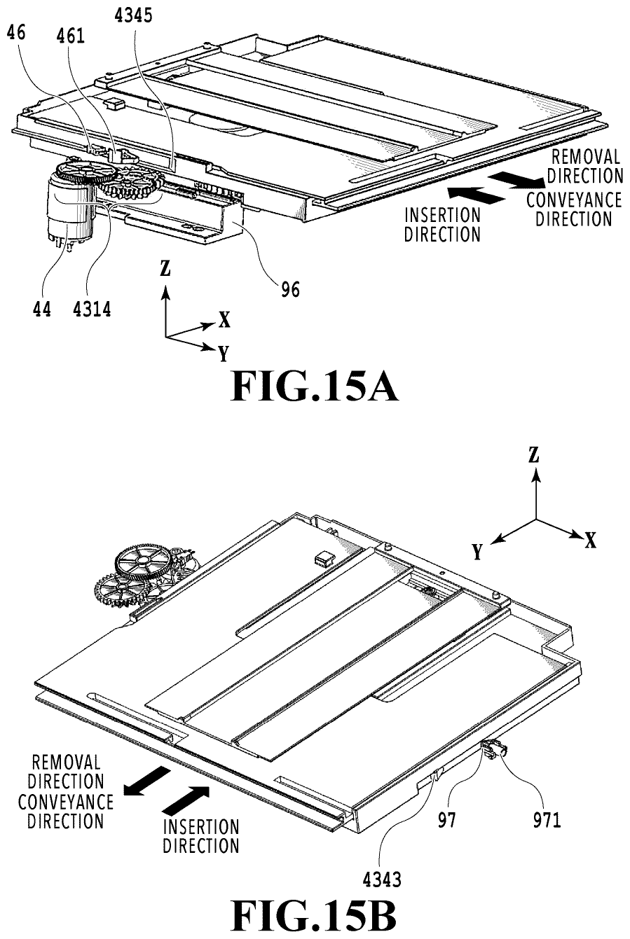

FIG. 14B shows the stacking unit 4 in FIG. 14A upside down. As shown in FIG. 14B, the first support member 434 holds a drive train 4313 formed by a plurality of drive transmission members for transmitting a drive force transmitted from the drive source 44 (see FIGS. 15A and 15B).

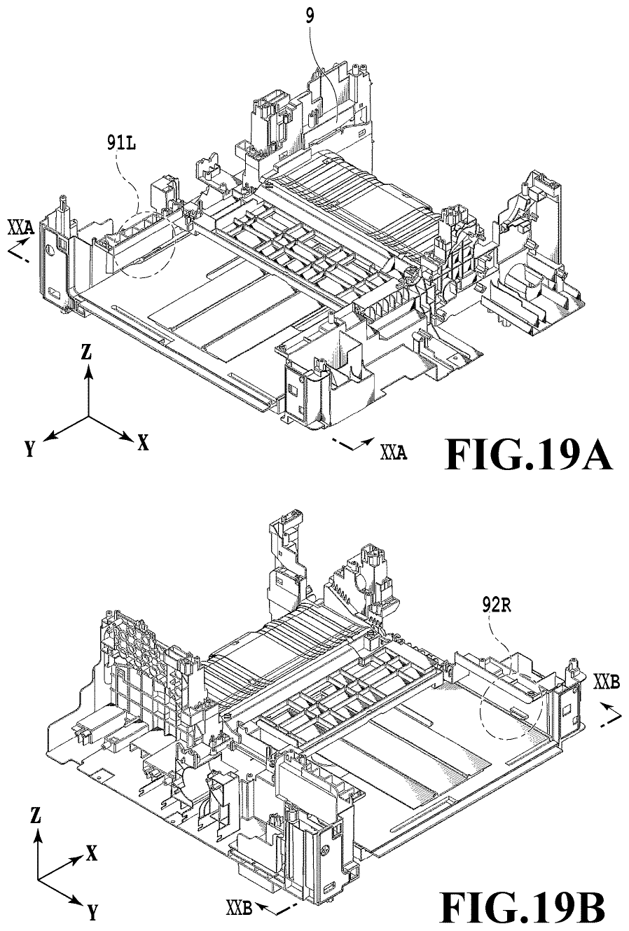

FIGS. 15A and 15B are perspective views showing the direction in which the stacking unit 4 is inserted (the −Y-direction) and the direction in which the stacking unit 4 is removed (the +Y-direction) as well as the direction in which a printing medium is conveyed (the +Y-direction). The printing apparatus 1 includes a guide member 96 configured to determine the position of the stacking unit 4 in the apparatus's width direction (the X-direction) and in the apparatus's height direction (the Z-direction). The printing apparatus 1 also includes a compression spring 971 configured to apply a load to the stacking unit 4 in the apparatus's width direction and a stacking-unit stopper 97 having a slanted tip shape to divide the load from the compression spring 971 into the apparatus's width direction (the X-direction, or specifically the −X-direction) and the direction in which the stacking unit 4 is removed (the +Y-direction). The stacking-unit stopper 97 is provided in the casing 9 of the printing apparatus 1 (see FIGS. 19A and 19B). Also, the printing apparatus 1 includes a drive train 4314 connecting the drive source 44 to the drive train 4313 held by the stacking unit 4 (see FIG. 14B), and with the stacking unit 4 attached to the printing apparatus 1, the drive train 4313 and the drive train 4314 mesh with each other. Note that the direction in which the stacking unit 4 is removed (the +Y-direction) and the direction in which the stacking unit 4 is inserted (the −Y-direction) are hereinafter referred to simply as a “removal direction” and an “insertion direction,” respectively.

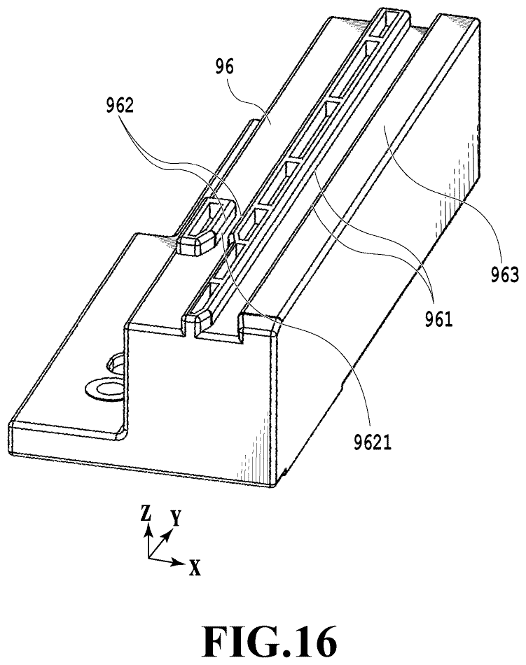

FIG. 16 is a perspective view of the guide member 96. The guide member 96 includes a rough guide rail 961 configured to roughly determine the position of the stacking unit 4 in the apparatus's width direction, a positioning guide rail 962 configured to precisely determine the position of the stacking unit 4 in the apparatus's width direction, and a surface rib 963 configured to determine the position of the stacking unit 4 in the apparatus's height direction. The positioning guide rail 962 has a surface 9621 against which the stacking unit 4 abuts in the apparatus's width direction (the X-direction).

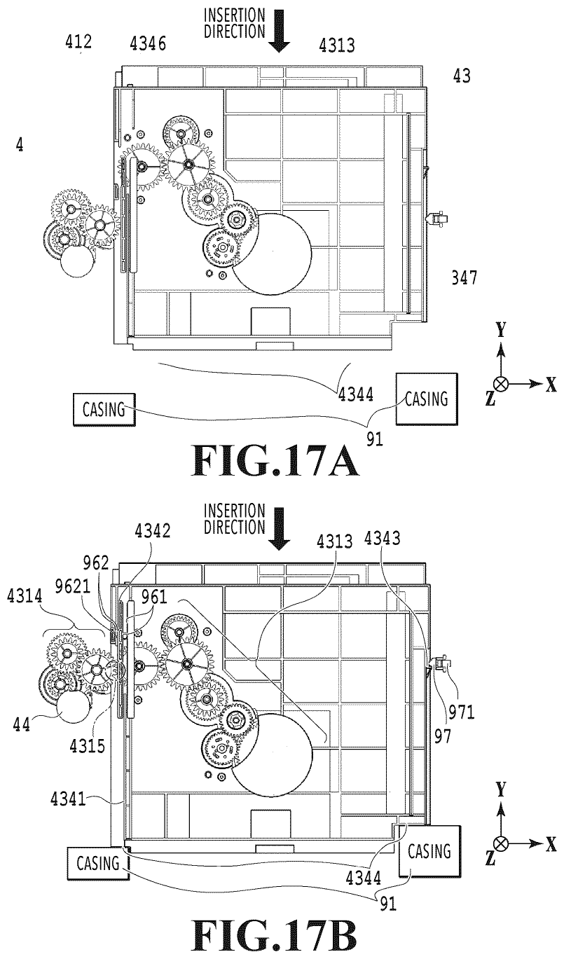

FIGS. 17A and 17B are diagrams showing a configuration for fixating the position of the stacking unit 4 in terms of the position in the apparatus's width direction (the X-direction) and the position in the conveyance direction (the Y-direction). FIG. 17A shows a state just before the stacking unit 4 is attached to the printing apparatus 1, and the printing apparatus 1 has the drive train 4313 provided at the stacking unit 4 side and the drive train 4314 provided at the casing side. In the state shown in FIG. 17A, the drive train 4313 and the drive train 4314 do not mesh with each other. FIG. 17B shows a state where the stacking unit 4 is attached to the printing apparatus 1, and the drive train 4313 on the stacking unit 4 side and the drive train 4314 on the casing side mesh with each other. A part where these drive trains mesh is referred to as a drive-train meshing part 4315.

### (Positioning of the Stacking Unit in the Apparatus's Width Direction)

As shown in FIG. 17A, the stacking unit 4 is held with its rough position in the apparatus's width direction determined by an apparatus-width-direction rough guide rib 4341 of the stacking unit 4 and the rough guide rail 961 of the guide member 96. Also, as shown in FIG. 17B, the position of the stacking unit 4 in the apparatus's width direction is precisely determined by a width-direction positioning rib 4342 of the stacking unit 4 and the positioning guide rail 962 of the guide member 96.

As shown in FIG. 17B, the stacking-unit stopper 97 is provided at the opposite side from the drive-train meshing part 4315 and the guide rail 962. The first support member 434 is provided with a rib 4343 that receives a pressing force from the stacking-unit stopper 97. The position of the stacking unit 4 is determined with the stacking unit 4 being pressed in the apparatus's width direction (specifically the −X-direction) by the pressing force from the stacking-unit stopper 97, i.e., with the width-direction positioning rib 4342 of the stacking unit 4 and the surface 9621 of the guide member 96 being in contact with each other. The width-direction positioning rib 4342 of the stacking unit 4 abuts against the guide member 96 (specifically the positioning guide rail 962) in the −X-direction and thus removes backlash in the X-direction, which reduces inter-shaft variability between the drive train 4313 and the drive train 4314 at the drive-train meshing part 4315. This helps prevent shallow meshing of the gears and tooth skipping.

### (Positioning of the Stacking Unit in the Apparatus's Conveyance Direction)

In a transition from the state in FIG. 17A to the state in FIG. 17B, the rib 4343 of the first support member moves in the insertion direction (the −Y-direction) and passes the Y-direction position of the stacking-unit stopper 97. In this event, the rib 4343 of the first support member is receiving the pressing force in the insertion direction (the −Y-direction) from the stacking-unit stopper 97, and the stacking unit 4 is positioned with an abutment portion 4344 abutting against a casing 91.

The second support member 432 (see FIG. 14A) configured to move in the conveyance direction has a rack portion and is extended or retracted by a pinion (not shown). In order for the stacking unit 4 not to come off as a result of extension of the second support member 432, the load of the compression spring 971 is set based on the force in the removal direction exerted to the stacking unit 4 upon the extension and on the force in the removal direction exerted upon abutment after the extension. However, the load needs to be set appropriately since too much load of the compression spring 971 results in requiring a user to apply a large operation force in insertion and removal of the stacking unit 4.

### (Detection of the Presence of the Stacking Unit)

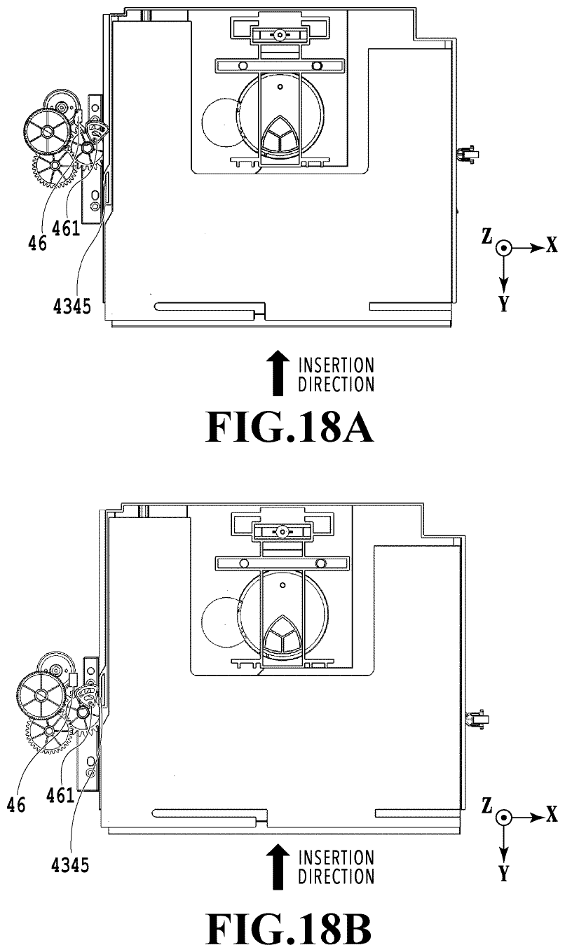

FIGS. 18A and 18B are diagrams showing a configuration for detecting detachment of the stacking unit 4 from the printing apparatus 1 (specifically the casing) and attachment of the stacking unit 4 to the printing apparatus 1 (the casing). In the present embodiment, the printing apparatus 1 has a leaf switch sensor 46 as the configuration for detecting the presence/absence of the stacking unit 4. A joint member 461 is provided to secure a distance from the leaf switch sensor 46 in order to prevent the user from directly touching the leaf switch sensor 46 and to reduce influence of electrostatic electricity. The joint member 461 is capable of turning, and the first support member 434 includes a protruding shape 4345 to push this joint member 461.

In attachment of the stacking unit 4 to the printing apparatus 1, the joint member 461 is pressed by the protruding shape 4345 and thereby turns, and this turning joint member 461 causes the signal from the leaf switch sensor 46 to be ON. Attachment of the stacking unit 4 can thus be detected. By contrast, in detachment of the stacking unit 4 from the printing apparatus 1, the joint member 461 is returned to the initial position by a press-back force from the tip switch portion of the leaf switch sensor 46, causing the signal from the leaf switch sensor 46 to be OFF. Detachment of the stacking unit 4 can thus be detected.

Note that the configuration for detecting the presence of the stacking unit 4 is not limited to the one described above. For example, the following configurations are possible: the first support member has a flag shape which is detected by a photo interactive sensor; and a linear scale is attached to the first support member and the position is detected by an optical sensor. Also, as yet another configuration, for example, the drive source 44 is operated, and the difference between the load exerted with the drive train 4313 and the drive train 4314 meshing with each other and the load exerted without the drive train 4313 and the drive train 4314 meshing with each other is detected using a PWM signal. Specifically, in a case where the value of the PWM signal obtained exceeds a predetermined threshold, it is determined that the stacking unit 4 is present, and in a case where the value of the PWM signal obtained does not exceed the predetermined threshold, it is determined that the stacking unit 4 is absent.

Unlike a finisher attached optionally, the stacking unit 4 of the present embodiment guarantees the printing operation of the printing apparatus 1 by being attached to the printing apparatus 1; thus, the configuration for detecting the presence of the stacking unit 4 is not optional.

### (Positioning of the Stacking Unit in the Apparatus's Height Direction)

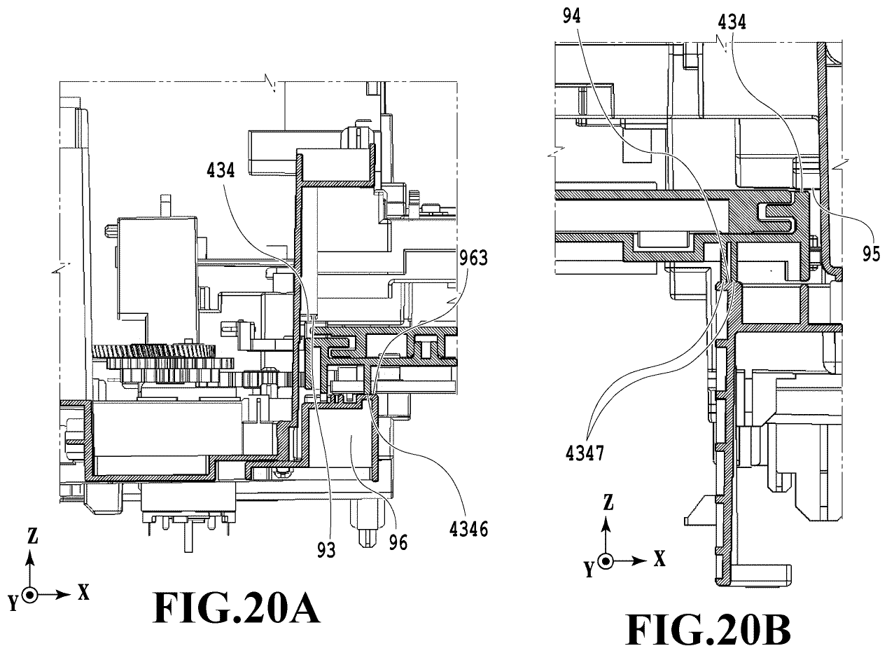

Positioning of the stacking unit 4 in the apparatus's height direction is described below using FIGS. 19A and 19B and FIGS. 20A and 20B. FIGS. 19A and 19B are perspective views showing a configuration for determining the position of the stacking unit 4 in the apparatus's height direction. FIGS. 20A and 20B are sectional views each showing the configuration for determining the position of the stacking unit 4 in the apparatus's height direction.

FIGS. 19A and 19B show the casing which is where the stacking unit 4 to be attached to the printing apparatus 1 is attached, FIG. 19A showing a leftward place 91L as seen from the front of the printing apparatus 1, as a place for determining the position of the stacking unit 4 in the apparatus's height direction, FIG. 19B showing a rightward place 92R as seen from the front of the printing apparatus 1, as a place for determining the position of the stacking unit 4 in the apparatus's height direction. FIG. 20A shows a sectional view of the place 91L, and FIG. 20B is a sectional view of the place 92R.

As a configuration for determining the position of the stacking unit 4 in the apparatus's height direction, the present embodiment employs a configuration where the first support member 434 is sandwiched from above and below using a casing shape or the like. At the left side of the apparatus, a height-direction positioning rib 4346 is in contact with the surface rib 963 of the guide member 96, and the upper side of the first support member 434 is sandwiched by a casing 93. At the right side of the apparatus, a height-direction positioning rib 4347 is in contact with a casing 94, and the upper side of the first support member 434 is sandwiched by a casing 95. Note that the guide member 96, the casing 93, the casing 94, and casing 95 may be formed integrally as the casing of the printing apparatus 1 or may be formed as separate bodies.

### (Processing for Clearing a Paper Jam Occurring in Double-Sided Printing)

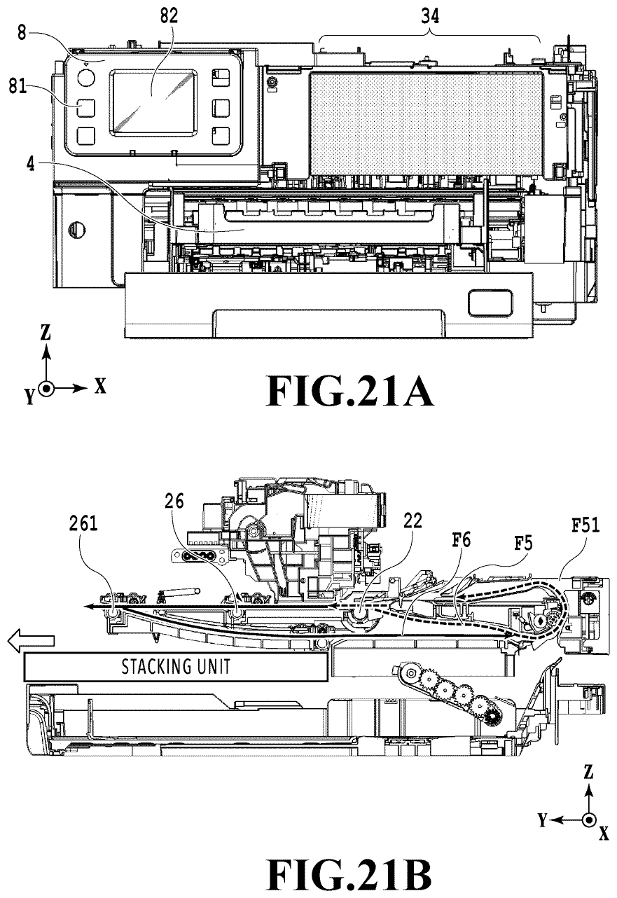

FIGS. 21A and 21B are diagrams showing the printing apparatus 1 of the present embodiment, where a conveyance path for a printing medium (called a paper path here) is formed above the stacking unit 4. Specifically, FIG. 21A shows a front view of the printing apparatus 1, and FIG. 21B shows a sectional view of the printing apparatus 1. Note that, as will be described later, FIG. 21B shows the paper path with arrows.

As shown in FIG. 21A, the printing apparatus 1 has the operation unit 8, and the operation unit 8 has the display panel 82 for displaying information on, e.g., the status of the printing apparatus 1 and the operation button 81 for selecting and executing an item displayed on the display panel 82. Also, the printing apparatus 1 has the liquid storage unit 34.

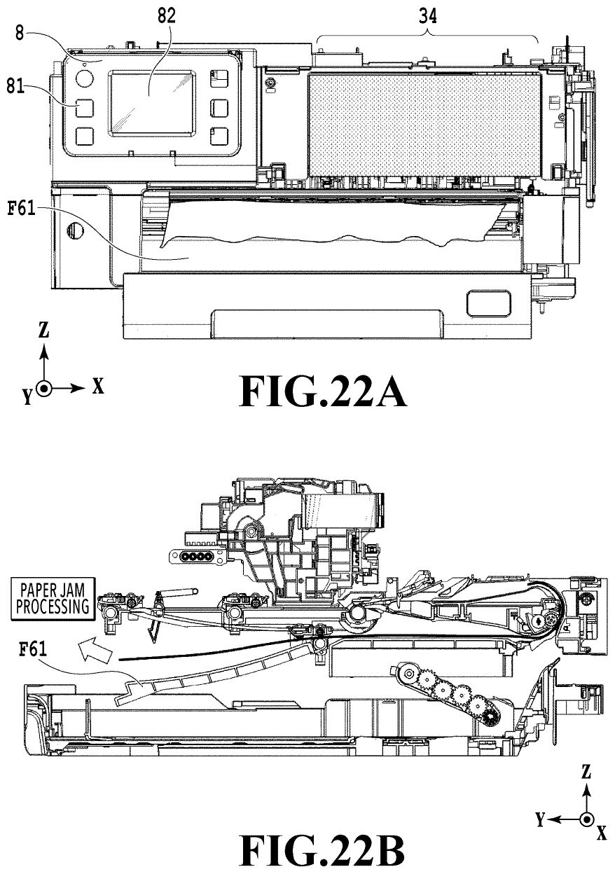

As shown in FIG. 21B, the conveyance unit 2 configured to convey a printing medium is provided with a conveyance roller 22, a first discharge roller 26, and a second discharge roller 261. For double-sided printing of a printing medium with short length, a short-length double-side path F5 indicated with broken-line arrows is used as a path for drawing in the printing medium by rotating the conveyance roller 22 in reverse (clockwise in FIG. 21B). By contrast, for double-sided printing of a printing medium with long length, a long-length double-side path F6 indicated with solid-line arrows is used as a path for drawing in the printing medium by rotating the second discharge roller 261 in reverse (clockwise in FIG. 21B). In a case where a paper jam occurs in the short-length double-side path F5, a user can clear the paper jam by taking off a cover F51 at the back face of the apparatus and removing the printing medium from the short-length double-side path F5. By contrast, in a case where a paper jam occurs in the long-length double-side path F6, because there is no convenient opening, the paper jam likely cannot be cleared easily, often requiring a procedure such as causing the jammed printing medium to be fed manually. The configuration of the stacking unit 4 of the present embodiment can resolve a problem. This point is described below using FIGS. 22A and 22B.

FIGS. 22A and 22B show how a paper jam in the paper path above the stacking unit 4 is cleared in the printing apparatus 1, FIG. 22A showing a front view of the printing apparatus 1 where a paper jab is occurring, FIG. 22B showing a sectional view of the printing apparatus 1.

As shown in FIG. 22B, the stacking unit 4 is detachable from the printing apparatus 1. Thus, should a paper jam occur in the long-length double-side path F6, a user detaches the stacking unit 4 and opens a long-length double-side path cover F61 which can be turned. This uncovers (exposes) the conveyance unit 2 (the conveyance path) through the opening, enabling the user to easily access the jammed printing medium and to therefore remove the printing medium and clear the paper jam. Note that upon detachment of the stacking unit 4 from the printing apparatus 1, the long-length double-side path cover F61 may automatically open to expose the conveyance path.

### (Paper Jam Error Recovery Processing)

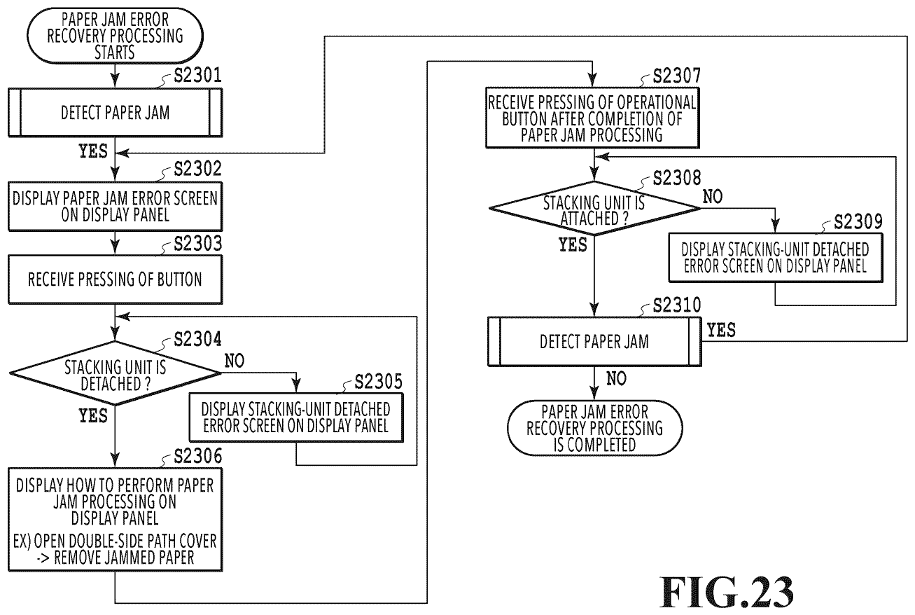

Using FIG. 23, the following describes paper jam error recovery processing of the present embodiment, i.e., processing where a paper jam state is recovered to a regular state. FIG. 23 is a flowchart of the paper jam error recovery processing.

In S2301, the control unit 71 performs paper jam detection. In an example of this paper jam detection, the control unit determines that a paper jam has occurred in a case where a paper detection sensor detects paper even though the conveyance amount (specifically the number of revolutions) of the conveyance roller 22 exceeds a predetermined threshold indicating an estimated number of revolutions for discharging a printing medium. Note that the paper detection sensor is a sensor provided inside the printing apparatus 1 and configured to detect the presence/absence of a printing medium.

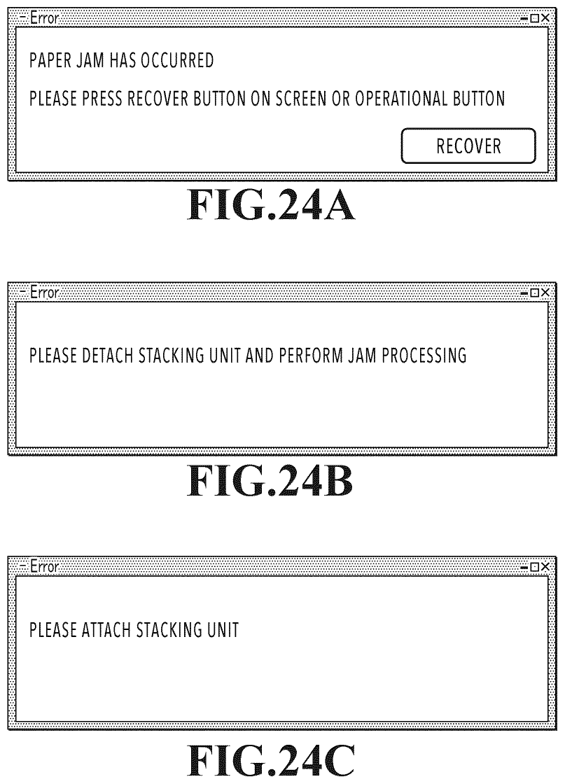

In S2302, the control unit 71 displays, on the display panel 82, a screen indicating that a paper jam error has occurred. As an example of the screen displayed in this step, FIG. 24A shows a user interface (UI) for notifying a user that a paper jam has occurred. Seeing this UI, the user instructs the printing apparatus 1 to perform a recovery operation by pressing either a “Recover button” forming the UI or the operation button 81.

In S2303, the control unit 71 receives the user's pressing of the button, specifically, pressing of the “Recover button” shown in FIG. 24A or pressing of the operation button 81. As described above, to clear the paper jam, the stacking unit 4 needs to be detached to expose the conveyance unit 2. Thus, after S2303, the user needs to detach the stacking unit 4 from the printing apparatus 1.

In S2304, the control unit 71 performs the above-described detection of the presence/absence of the stacking unit 4 and thereby determines whether the stacking unit 4 has been removed. If the result of the determination in this step is YES, the processing proceeds to S2306. If the result of the determination in this step is NO, the processing proceeds to S2305.

In S2305, the control unit 71 displays a screen prompting the user to detach the undetached stacking unit 4 (an stacking-unit undetached error screen) on the display panel 82 to prompt the user to detach the stacking unit 4. As an example of the screen displayed in this step, FIG. 24B shows an UI including a message prompting the user to detach the stacking unit 4, “Please detach the stacking unit and perform jam processing.”

In S2306, the control unit 71 displays, on the display panel 82, a UI presenting how to perform the paper jam processing. An example of the UI displayed in this step is an UI such as an illustration or a video showing opening the long-length double-side path cover F61 and removing a paper jam. Seeing the UI displayed in this step, the user follows the instruction displayed and performs the paper jam processing for removing the jammed printing medium from the paper path. After that, after judging that the paper jam processing has completed, the user presses the operation button 81 to notify the printing apparatus 1 of the completion.

In S2307, the control unit 71 receives the pressing of the operation button 81 by the user who judged that the paper jam processing had completed. Note that, although the above shows a mode where the control unit 71 judges that the paper jam processing has completed based on pressing of the operation button 81 by the user, the control unit 71 may judge completion of the paper jam processing by determining absence of paper using the paper detection sensor inside the printing apparatus 1.

In S2308, the control unit 71 performs the above-described detection of the presence/absence of the stacking unit 4 and thereby determines whether the stacking unit 4 has been attached. If the determination result in this step is YES, the processing proceeds to S2310, and if the determination result in this step is NO, the processing proceeds to S2309.

In S2309, the control unit 71 displays, on the display panel 82, a screen indicating that the stacking unit 4 is not attached (a stacking-unit unattached error screen). As an example of the screen displayed in this step, FIG. 24C shows an UI including a message prompting the user to attach the stacking unit 4, “Please attach the stacking unit.”

In S2310, the control unit 71 performs paper jam detection. The paper jam detection in this step is similar to the processing in S2301 and is performed to check whether the paper jam processing has been performed correctly. If a paper jam is detected in this step, the processing proceeds back to S2308. If no paper jam is detected in this step, the series of steps of paper jam error recovery processing is completed.

### Advantageous Effects of the Present Embodiment

As described above, the printing apparatus of the present embodiment has a configuration where the stacking unit is detachable from the printing apparatus, the stacking unit being capable of extending and retracting in the direction in which the printing medium is conveyed (the Y-direction) and capable of moving in a reciprocating manner in a direction (the X-direction) perpendicular to the conveyance direction. Should a jam occur inside the printing apparatus, this configuration makes it easy to remove the jammed printing medium from the conveyance path and therefore contributes to improvement in useability.

### OTHER EMBODIMENTS

Note that the embodiment described above may be modified as described in (1) to (9) below.

(1) Although no particular mention is made in the above-described embodiment, the printing apparatus 1 can select, based on an input entered through the operation unit 8 or the like, either a print processing where a printing medium is printed while being sorted (see FIGS. 12A and 12B) and a print processing where a printing medium is printed without being sorted. In the print processing where the sorting is not executed, for example, a printed printing medium keeps being discharged after the stacking unit 4 is moved to the first sorting position and the second stacking part 42 is moved to the stack position. Also, in the print processing where the sorting is not executed, for example, if it is determined in S1218 that the copy number n has not reached the predetermined number of copies, the processing proceeds to S1240. Further, in the print processing where the sorting is not executed, for example, S1202 and 1222 may be omitted.

Note that the above embodiment describes, using the flowchart in FIGS. 12A and 12B, a case where an instruction to “sort N copies of M sheets” is inputted through a job or the operation unit 8 in the present embodiment. However, in an actual print operation, even if M and N are known, a user may specify not to execute sorting. In such a case, a configuration for switching whether to transmit a drive force from the drive source 44 to the engagement portion 4333 is provided in advance, and in a case where sorting is not performed, the stacking unit 4 may be controlled not to move between the first sorting position and the second sorting position.

(2) In the above embodiment, the drive transmission unit 43 is formed so that, with the first stacking part 41 located at the first sorting position, the cam 4312 will not rotate further even if the drive source 44 rotates in the first direction and transmits a drive force thereto. However, the configuration of the drive transmission unit 43 is not limited to this. For example, the drive transmission unit 43 may be formed so that, with the first stacking part 41 located at a predetermined position closer to one side in the X-direction than the first sorting position, the cam 4312 will not rotate further even if the drive source 44 rotates in the first direction and transmits a drive force thereto. In this case, in the print processing in FIGS. 12A and 12B, after the first stacking part 41 is moved to the aforementioned position, the drive source 44 is rotated further in the first direction, thereby moving the second stacking part 42 from the housed position to the stack position. After that, the drive source 44 rotates in the second direction to move the first stacking part 41 in the +X-direction to the first sorting position. The position of the first stacking part 41 here is based on the result of detection by the sensor included in the detection unit 73 and configured to detect the position where the stacking unit 4 is located after a predetermined operation.

(3) In the embodiment described above, the drive transmission unit 43 is formed so that, with the first stacking part 41 located at the second sorting position, the cam 4312 will not rotate further even if the drive source 44 rotates in the second direction and transmits a drive force thereto. However, the configuration of the drive transmission unit 43 is not limited to this. For example, the drive transmission unit 43 may be formed so that, with the first stacking part 41 located at a predetermined position closer to the other side in the X-direction than the second sorting position, the cam 4312 will not rotate further even if the drive source 44 rotates in the second direction and transmits a drive force thereto.

(4) In the embodiment described above, the second stacking part 42 is such that, at the housed position, a part thereof on the end portion 42a side protrudes forward from the casing 9 in the Y-direction (see FIG. 6A); however, the present disclosure is not limited to this. The second stacking part 42 at the housed position may be configured not to protrude forward from the casing 9. Thus, in this case, at the housed position, the second stacking part 42 is completely housed inside the casing 9. Also, in the embodiment described above, discharged printing media are sorted by being stacked on the stacking unit 4 at two locations: the first sorting position and the second sorting position. However, the positions for sorting are not limited to two locations. For example, discharged printing media may be sorted at three or more locations differing in the X-direction.

(5) In the embodiment described above, the printing apparatus 1 is what is called a serial-scan-type printing apparatus configured to print on a conveyed printing medium by ejecting ink to the printing medium from the printhead 3 moving in the X-direction. However, the present disclosure is not limited to this. The printing apparatus to which the present disclosure can be applied may be, for example, what is called a line-type printing apparatus configured to print on a printing medium conveyed in the Y-direction using a printhead capable of ejecting ink over a printable region extending in the X-direction over the size of the printing medium.

(6) In the embodiment described above, the first sorting position is such that the center position Os of the stacking unit 4 in the X-direction is located closer to one side in the X-direction than the center position Om of a printing medium discharged, and the second sorting position is such that the center position Os is closer to the other side in the X-direction than the center position Om. However, the first sorting position and the second sorting position are not limited to this. For example, one of the first sorting position and the second sorting position may be such that the center position Os coincides with the center position Om. Also, in the embodiment described above, at the initial position where the stacking unit 4 is located while no printing is performed, the center position Os of the stacking unit 4 coincides with the center position Os of a discharged printing medium. However, the present disclosure is not limited to this. The initial position may be the first sorting position, the second sorting position, or a predetermined position different from the first sorting position or the second sorting position.

(7) The present embodiment describes a case where an instruction to “sort N copies of M sheets” is set in a job. However, in a job, a command instructing to change the sorting position may be interposed between image data on a certain page and image data on the next page. In such a mode, the control unit 71 executes operations sequentially as instructed by the command received, such as printing and discharging according to the image data on the certain page, changing of the sorting position, and then printing and discharging according to the image data on the next page.

(8) In the embodiment described above, the stacking unit 4 is moved in the Y-direction and the X-direction to sort printing media discharged. Alternatively, sorting of printing media discharged may be performed by moving the stacking unit 4 not in the Y-direction but only in the X-direction.

(9) The various modes described in the present embodiment and in (1) to (8) above may be combined as needed.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure makes it easy to clear a jam in a printing apparatus having a stacking unit configured to sort a printing medium in a direction orthogonal to the direction in which the printing medium is conveyed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-124742, filed Jul. 31, 2024, which is hereby incorporated by reference herein in its entirety.

What is claimed is:

1. A printing apparatus comprising:
a casing;
a conveyance unit housed in the casing and configured to convey a printing medium; and
a stacking unit which is attached to the casing and on which a printing medium conveyed by the conveyance unit is to be stacked, wherein
the stacking unit has a first stacking part movable in a second direction intersecting with a first direction in which a printing medium is conveyed and a second stacking part movable in the first direction relative to the first stacking part, and
the stacking unit is detachable from the casing by moving in the first direction.

2. The printing apparatus according to claim 1, further comprising a control unit, wherein
the control unit moves the first stacking part in the second direction and moves the second stacking part in the first direction.

3. The printing apparatus according to claim 2, further comprising a detection unit configured to detect whether the stacking unit is attached to the casing or is detached from the casing.

4. The printing apparatus according to claim 3, further comprising an operation unit configured to be operated by a user, wherein
the operation unit has a display panel used to display information based on a result of detection by the detection unit and an operation button used to select or execute an item displayed on the display panel.

5. The printing apparatus according to claim 4, further comprising a determination unit configured to determine, in a case where a jam occurs, whether the stacking unit is detached based on the result of detection by the detection unit, wherein
in a case where the determination unit determines that the stacking unit is not detached, the control unit displays, on the display panel, a user interface prompting the user to detach the stacking unit.

6. The printing apparatus according to claim 5, wherein
in a case where the determination unit determines that the stacking unit is detached, the control unit displays, on the display panel, a user interface showing how to perform jam processing.

7. The printing apparatus according to claim 6, wherein
above the stacking unit, there is a conveyance path for a printing medium to be printed on both sides.

8. The printing apparatus according to claim 7, wherein
detaching the stacking unit from the casing exposes the conveyance path.

9. The printing apparatus according to claim 8, wherein
by moving the first stacking part in the second direction, the stacking unit is capable of sorting a printing medium at positions different in the second direction.

10. The printing apparatus according to claim 9, wherein
the stacking unit has a first drive train configured to transmit a drive force for moving the first stacking part in the second direction,
the casing has a drive source and a second drive train, and
with the stacking unit attached to the casing, the first drive train and the second drive train mesh with each other.

11. The printing apparatus according to claim 10, further comprising a press unit configured to determine a position of the stacking unit relative to the casing, wherein
with the stacking unit attached to the casing, the stacking unit receives a force from the press unit in a direction in which the first drive train is pressed against the second drive train.

12. The printing apparatus according to claim 11, wherein
a drive train meshing part where the first drive train and the second drive train mesh with each other is located at one side of the casing in terms of the second direction, and
the press unit is located at an opposite side of the casing in terms of the second direction.

13. The printing apparatus according to claim 12, wherein
with the stacking unit attached to the casing, the stacking unit receives a force from the press unit in a direction opposite from the first direction.

14. The printing apparatus according to claim 13, further comprising a printing unit housed in the casing and configured to print an image on a printing medium conveyed by the conveyance unit.

15. A printing apparatus comprising:
a casing;
a conveyance unit housed in the casing and configured to convey a printing medium; and
a stacking unit which is attached to the casing and on which a printing medium conveyed by the conveyance unit is to be stacked, wherein
the stacking unit is movable in a second direction intersecting with a first direction in which a printing medium is conveyed, and
a conveyance path in the conveyance unit is exposed in a case where the stacking unit is detached from the casing.

16. A control method for controlling a printing apparatus having
a casing,
a conveyance unit housed in the casing and configured to convey a printing medium, and
a stacking unit on which a printing medium conveyed by the conveyance unit is to be stacked, the stacking unit having a first stacking part movable in a second direction intersecting with a first direction in which a printing medium is conveyed and a second stacking part movable in the first direction relative to the first stacking part, the stacking unit being detachable from the casing by moving in the first direction, the control method comprising:
moving the first stacking part in the second direction and
moving the second stacking part in the first direction.

17. A non-transitory computer readable storage medium storing a program which causes a computer to execute a control method for controlling a printing apparatus having
a casing,
a conveyance unit housed in the casing and configured to convey a printing medium, and
a stacking unit on which a printing medium conveyed by the conveyance unit is to be stacked, the stacking unit having a first stacking part movable in a second direction intersecting with a first direction in which a printing medium is conveyed and a second stacking part movable in the first direction relative to the first stacking part, the stacking unit being detachable from the casing by moving in the first direction, the control method comprising:
moving the first stacking part in the second direction and
moving the second stacking part in the first direction.
